(19) United States
(12) Patent Application Publication
(10) Pub. No.: US 2019/0378210 A1
(43) Pub. Date: Dec. 12, 2019

(54) SYSTEMS AND METHODS FOR DECOMPOSITION OF NON-DIFFERENTIABLE AND DIFFERENTIABLE MODELS

(71) Applicant: ZestFinance, Inc., Los Angeles, CA (US)

(72) Inventors: Douglas C. Merrill, Los Angeles, CA (US); Michael Edward Ruberry, Los Angeles, CA (US); Sean Javad Kamkar, Los Angeles, CA (US); Jerome Louis Budzik, Los Angeles, CA (US); John Wickens Lamb Merrill, Los Angeles, CA (US)

(21) Appl. No.: 16/434,731

(22) Filed: Jun. 7, 2019

Related U.S. Application Data
(60) Provisional application No. 62/682,714, filed on Jun. 8, 2018.

(51) Int. Cl. G06Q 40/02; G06N 20/00; G06N 5/02

(52) U.S. Cl. CPC G06Q 40/025; G06N 5/02; G06N 20/00

(57) ABSTRACT

Systems and methods for explaining non-differentiable models and differentiable models.

### CROSS-REFERENCE TO RELATED APPLICATIONS

This application claims the benefit of U.S. Provisional Application No. 62/682,714 filed 8 Jun. 2018, which is incorporated in its entirety by this reference.

### TECHNICAL FIELD

This disclosure relates generally to the machine learning field, and more specifically to new and useful systems and methods for providing model explainability information for a machine learning model by using decomposition.

### BACKGROUND

As complexity of machine learning systems increases, it becomes increasingly difficult to explain results generated by machine learning systems.

### BRIEF DESCRIPTION OF THE FIGURES

FIGS. 1A and 1B are schematic representations of a system, according to embodiments;

FIG. 2 is a representation of a method, according to embodiments;

FIG. 3 is a representation of a table, according to embodiments;

FIG. 4 is a diagram depicting system architecture of a model evaluation system, according to embodiments;

FIG. 5 is a diagram depicting a modelling system, according to embodiments;

FIG. 6 is a representation of a procedure, according to embodiments; and

FIGS. 7A-C are representations of a procedure, according to embodiments.

### DESCRIPTION OF EMBODIMENTS

The following description of embodiments is not intended to limit the disclosure to these embodiments, but rather to enable any person skilled in the art to make and use the embodiments disclosed herein.

### 1. OVERVIEW

As complexity of machine learning systems increases, it becomes increasingly difficult to explain results generated by machine learning systems. While computer scientists understand the specific algorithms used in machine learning modelling, the field has generally been unable to provide useful explanations of how a particular model generated by anything but the simplest of algorithms works. This has limited their adoption by businesses seeking to solve high stakes problems which require transparency into a model's inner workings.

There is a need in the machine learning field for new and useful systems for explaining results generated by machine learning models. The disclosure herein provides such new and useful systems and methods. In particular, there is a need in the machine learning field to provide model explainability information for a machine learning model in order to comply with regulations such as the Equal Credit Opportunity Act, the Fair Credit Reporting Act, and the OCC and Federal Reserve Guidance on Model Risk Management, which require detailed explanations of the model's overall decision making, explanations of each model-based decision, and explanations of differences in model decisions between two or more segments of a population.

Disparate impact under some laws and regulations, e.g., 15 U.S.C. § 1691, 42 U.S.C. § 3604, incorporated herein by reference, refers to practices in employment, housing, insurance, and other areas that adversely affect one group of people of a protected characteristic more than another, even though rules applied by government entities, businesses, employers or landlords, for example, appear to be neutral and non-discriminatory. Some protected classes include classes based on race, color, religion, national origin, sex, age, and disability status as protected characteristics.

A violation of a law or regulation may be proven by showing that an employment practice or policy has a disproportionately adverse effect on members of the protected class as compared with non-members of the protected class. Therefore, the disparate impact theory prohibits employers from using a facially neutral employment practice that has an unjustified adverse impact on members of a protected class. A facially neutral employment practice is one that does not appear to be discriminatory on its face, but is discriminatory in its application or effect. Where a disparate impact is shown, a plaintiff can prevail in a lawsuit without the necessity of showing intentional discrimination unless the defendant entity demonstrates that the practice or policy in question has a demonstrable relationship to business requirements. This is the “business necessity” defense.

It is useful for an entity (e.g., government, business) that uses machine learning systems to make decisions to understand whether decisions generated by such machine learning systems have a disproportionately adverse effect on members of a protected class as compared with non-members of a protected class. However, as complexity of machine learning systems increases, it becomes increasingly difficult to determine whether outcomes generated by machine learning systems disparately impact a protected class. In particular, embodiments herein include a method of using machine learning model interpretations to determine whether a heterogeneous, ensembled model has disparate impact, which of the variables used in the model are driving the disparity, the degree to which they are driving the disparity, and their relationship to business objectives such as profitability.

There is a need in the machine learning field for new and useful systems for determining whether a machine learning model is likely to generate results that disparately impact a protected class. There is a further need to determine the degree to which each variable used in a model may be causing disparate impact, and the degree to which each variable may be driving financial outcomes such as losses, interest income, yield, and LTV, so that a model developer may take the required steps to comply with the applicable laws, regulation and guidance (e.g., by suppressing a problematic variable, or, in other cases, by justifying its business impact). The disclosure herein provides such new and useful systems and methods.

In addition to understanding how a model makes decisions in general, it is also useful to understand how a model makes a specific decision or how a model computes a specific score. Such explanations are useful so that model developers can ensure each model-based decision is reasonable. These explanations have many practical uses, and for some purposes they are particularly useful in explaining to a consumer how a model-based decision was made. In some jurisdictions, and for some automated decisioning processes, these explanations are mandated by law. For example, in the United States, under the Fair Credit Reporting Act 15 U.S.C. § 1681 et seq, when generating a decision to deny a consumer credit application, lenders are required to provide to each consumer the reasons why the credit application was denied, in terms of factors the model actually used, that the consumer can take practical steps to improve. These adverse action reasons and notices are easily provided when the model used to make a credit decision is a simple, linear model. However, more complex, ensembled machine learning models have heretofore proven difficult to explain. The disclosure herein provides such new and useful systems and methods for explaining each decision a machine learning model makes, and it enables businesses to provide natural language explanations for model-based decisions, so that businesses may use machine learning models, provide a better consumer experience and so that businesses may comply with the required consumer reporting regulations.

Machine learning models are often ensembles of heterogeneous sub-models. For example, a neural network may be combined with a tree-based model such as a random forest, or graident-boosted tree by averaging the values of each of the sub-models to produce an ensemble score. Other computable functions can be used to ensemble heterogeneous submodel scores. There is a need in the machine learning field for new and useful systems for explaining results generated by heterogeneous ensembles of machine learning models. The disclosure herein provides such new and useful systems and methods.

Machine learning models undergo a lifecycle, from development, to testing, analysis and approval, to production and ongoing operations. There is a need in the machine learning field for new and useful systems for storing, updating, and managing machine learning model metadata across the machine learning model lifecycle. The disclosure herein provides new and useful systems for automatically generating machine-readable descriptions of models, features, and analyses which can be used to create model governance and model risk management documentation throughout the modeling life cycle. The disclosure herein teaches the construction of new and useful systems that use model meta-data to monitor model performance in production, ensuring safety against anomalous inputs and outputs, and to detect changes in model performance over time. These systems and methods substantially contribute to an organization's compliance with OCC Bulletin 2011-12, Supervisory Guidance on Model Risk Management, which is incorporated herein by reference.

Existing approaches to machine learning model explainability include permutation feature importance (sometimes called sensitivity analysis). Discussed in Breiman, Leo, “Random Forests”, 2001, many popular machine learning systems (e.g., Microsoft Azure Machine Learning Studio) incorporate permutation feature importance as a primary model explainability method. It is not obvious to most practitioners with ordinary skill in the art that such an approach might have severe and systematic limitations. The fundamental idea behind permutation impact is that by removing input features one-at-a-time from the model, the model performance, as judged by an appropriate accuracy metric, will degrade in a manner commensurate to the importance of the input feature, e.g., significant input features will yield substantial drops in accuracy, conversely, insignificant input features will yield insignificant changes. Actual implementations of permutation impact, given input data, targets (ground truth values) and a model, often first computes a baseline accuracy metric, e.g., Area Under the Curve (AUC), for the input dataset. It then randomly permutes each column independently, and computes a new AUC value. The result is a set of AUC differences for each feature in the model, which is then used to rank and evaluate the significance of all features. While this approach seems reasonable, it breaks down upon further scrutiny and analysis, and when applying it in the practice of building and explaining machine learning models, including linear models, ensembles of neural networks and trees, neural network models, including deep neural networks, recurrent neural networks, multilayer perceptrons, tree models, including random forests, CART, decision trees, gradient boosted decision trees, and any combination of the foregoing, including machine learning credit models, without limitation. These issues include:

1. Colinear features receive incorrect importance: a subtle but seldom appreciated fact is that machine learning models capture interactions between variables and are able to accommodate missing data. This very resilience of machine learning models might cause permutation feature importance to fall apart. For example, consider a model with three input variables may represent the same underlying information, e.g., one variable may indicate the number of bankruptcies reported by a first data source such as a first credit bureau, another variable may indicate the number of bankruptcies reported by a second data source such as a second credit bureau, and so on. A machine learning model, when trained on this input data may learn the co-linear relationship between the three bankruptcy input variables and be resilient to one dropping out. The model may highly value bankruptcy as a signal overall, but be resilient to variations in any one of the three bankruptcy input variables. As such, when applying permutation feature importance, the algorithm will shuffle each column independently, and because the model has learned the underlying relationship between the variables, the scores produced by the model when one of the bankruptcy signals is scrambled, will be similar to the original model score produced before the scrambling. Since the scores will not change much, the AUC will also not change much, and therefore the permutation feature importance analysis will indicate bankruptcies play a de minimis role in the credit model, even though the opposite is true. Thus, using permutation feature importance on a machine learning model can produce an incorrect characterization of the underlying model, causing a business to unwittingly make decisions or provide outputs that cause a modeler to mistakenly remove important variables and decrease model performance, a business could be unwittingly discriminating against protected classes, or it could mislead consumers as to the reasons a credit decision was made, and be in violation with applicable regulations and laws.

2. Permutation impact might be intractable. Relative to simplified models, modern machine learning algorithms gain much of their performance benefit from the high-dimensional multivariate relationships that are discovered among the input features. Understanding the full space of interactions requires O(N!M) computations, where N is the number of features, and M is the number of rows. For context, a model with 60 features would require more evaluations than atoms in the observable universe. A staggering result considering that hundreds or thousands of input features is quite common for models today, and that usually one seeks to evaluate multiple rows.

3. Permuted rows are off the model manifold: By virtue of the random univariate shuffling of model input data, permutation feature importance produces nonsensical input rows that are not drawn from the multivariate distribution the model is monitoring. This can produce undefined results, which yield incomplete and potentially dangerous conclusions. For example, in a credit risk modeling context, permutation importance could produce implausible applicants: e.g., an applicant with no bankruptcies, no collections, no court records, high income, and low credit usage, may be permuted to have a dozen bankruptcies, but still be presented to the model as having no court records, no collections, etc. There are no known practical workarounds to this limitation.

4. Permutation impact for any application, e.g., assessing feature importance, may produce an ordering, but the numeric importance measure, e.g., difference of AUC, might be uninterpretable. The highly non-linear mapping, which turns the difference of model accuracy onto a space of feature importance, might offer no clear interpretable basis. The underlying sensitivity, which drives the difference in accuracy metrics, is disconnected from the actual model output score for a given applicant. Such limitations might make it impossible to generate adverse action reasons that explain to the consumer what they would have to do to improve the score generated by the model.

5. Permutation impact for any application, e.g., assessing feature importance, might result in evaluations whereby the accuracy score may increase after a feature has been permuted. Conceptually, this suggests that the model is performing better without the presence of a given input feature. While this may imply that the model could be refit, without the harmful or noisy feature, and produce a higher overall accuracy, it often is an indication that the feature is highly correlated with other features and produces a net outcome that cannot be separated in a univariate manner—similar to the aforementioned issue of collinearity.

The above limitations to permutation feature importance are addressed by the disclosed embodiments.

Approaches to machine learning model interpretability include SHAP for trees (Lundberg et al., “Consistent Individualized Feature Attribution for Tree Ensembles”, 2018, https://arxiv.org/pdf/1802.03888vi.pdf) and Integrated Gradients (Sundararajan, et al., “Axiomatic Attribution for Deep Networks”, 2017, https://arxiv.org/abs/1703.01365) for differentiable models, the contents of each of which are incorporated by reference herein. Each describes methods of decomposing entirely different classes of machine learning models, trees and neural networks, respectively. It will be appreciated to one with ordinary skill in the art that tree based modeling approaches are frequently used on numeric data, while neural network modeling approaches are frequently used on image or video data and that the research communities pursuing tree based and neural networks are distinct and different. The disclosure herein describes a novel method for the decomposition of ensembles (combinations) of tree and neural network models that combines the SHAP and Integrated Gradients methods to produce a new and useful result (decomposition of ensemble models) which is used to perform new and useful analysis that results in tangible outputs that support human decision-making, e.g.: feature importance, adverse action, and disparate impact analysis, as described herein. The present disclosure advances the state of the art of decomposition techniques by extending the extant techniques to ensembles of heterogeneous submodels and discloses a practical method of applying decomposition to produce adverse action and disparate impact (fairness) analysis and other tangible outputs that support human decision-making. The present disclosure teaches methods that address limitations with existing explainability approaches by combining, extending, and making practical the approaches described in Lundberg and Lee 2017, and Sundararajan, et al., 2017. In particular methods disclosed herein teach novel implementations of SHAP and Integrated Gradients, how to combine the SHAP and Integrated Gradients to provide a unified decomposition of ensemble model results, how to reduce the computational complexity, how to address numerical stability, and practical application to row level, model level, and segment level explainability, including feature importance, adverse action, disparate impact, and model monitoring.

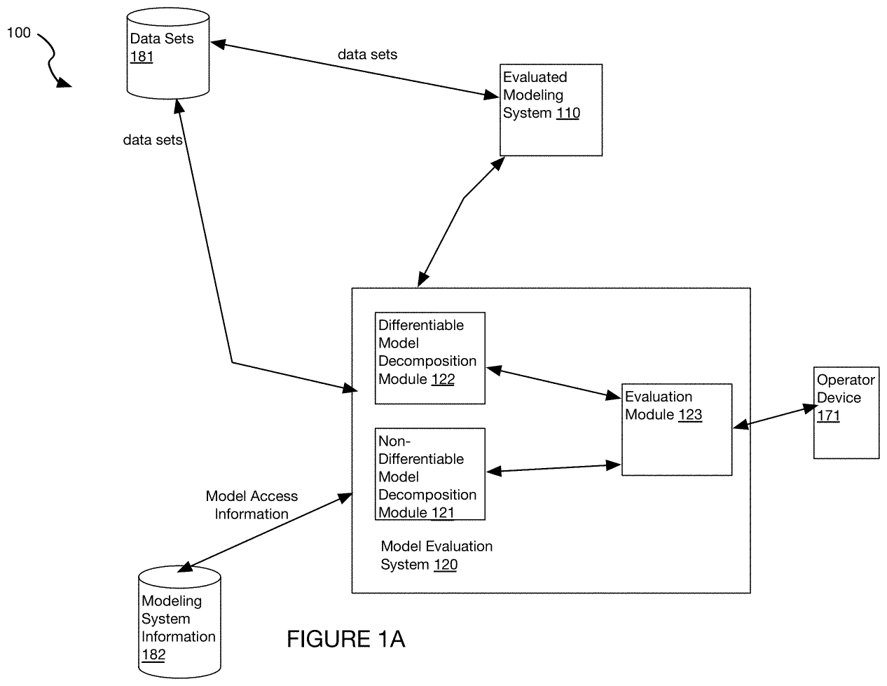

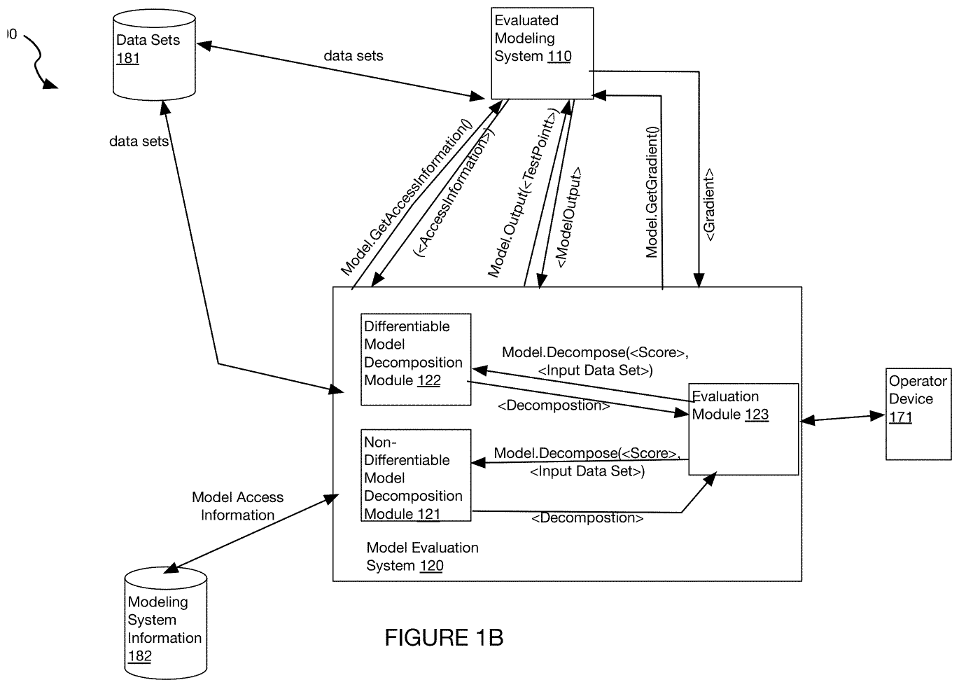

A model evaluation system and related methods are provided. In some embodiments, the model evaluation and explanation system (e.g., 120 of FIGS. 1A and 1B) uses a non-differentiable model decomposition module (e.g., 121) to explain models by reference by transforming SHAP attributions (which are model-based attributions) to reference-based attributions (that are computed with respect to a reference population of data sets). In some embodiments, the model evaluation and explanation system (e.g., 120 of FIGS. 1A and 1B) explains models by combining results of at least two types of decomposition modules. In some embodiments, the model evaluation and explanation system (e.g., 120 of FIGS. 1A and 1B) explains models by combining results of at least two types of decomposition modules, each of which is applied to one or more individual systems (e.g., models) for evaluating risk. In some embodiments, the model evaluation system 120 explains single models. In some embodiments, the model evaluation system 120 explains ensembles by explaining each sub-model of the ensemble and combining explanations of each sub-model by using an ensemblng function of the ensemble. In some embodiments, the ensembles are heterogeneous ensembles. In some embodiments, the ensembles are homogeneous ensembles.

In some embodiments, the model evaluation and explanation system (e.g., 120 of FIGS. 1A and 1B) uses a non-differentiable model decomposition module (e.g., 121) to decompose scores generated by a model by computing at least one SHAP (SHapley Additive exPlanation) value. In some embodiments, decomposing scores includes: for each feature of a test data point, generating a difference value, the difference value for the test data point relative to a corresponding reference data point, the difference value being the decomposition value for the feature. In some embodiments, generating a difference value for a feature includes: computing a SHAP value (as described herein) of the non-differentiable model for the test data point and computing a SHAP value of the non-differentiable model for the corresponding reference data point, and subtracting the SHAP value for the reference data point from the SHAP value for the test data point to produce the difference value for the feature. In some embodiments, the score decomposition functions as explanation information for the model that explains the score for the test data point (generated by the model, or ensemble) in terms of the score for the reference data point (also generated by the model, or ensemble). In some embodiments, the decomposition is used to generate explanation information for the model. In some embodiments, these decompositions are generated for plural pairs of test data points and corresponding reference data points, and the decompositions are used to explain the model. In this manner, SHAP attributions for a single test data point are transformed into reference-based attributions to the test data point in terms of the reference data point.

In some embodiments, the model evaluation and explanation system (e.g., 120 of FIGS. 1A and 1B) uses the non-differentiable model decomposition module (e.g., 121) and a differentiable model decomposition module (e.g., 122) to decompose scores generated by each sub-model of an ensemble model (e.g., a model of modeling system 110 of FIGS. 1A and 1B) that includes at least one non-differentiable model and at least one differentiable model, and the model evaluation system uses the decompositions generated by the non-differentiable model decomposition module and the differentiable model decomposition module to evaluate and explain the ensemble model. In some embodiments, the non-differentiable model decomposition module computes a score decomposition for a test data point relative to a reference data point for the non-differentiable model (as described herein), and the differentiable model decomposition module computes a score decomposition for the test data point relative to the reference data point for the differentiable model, and combines the decomposition of the non-differentiable model with the decomposition for the differentiable model by using an ensembling function of the ensemble model, to generate a decomposition for an ensemble model score for the test data point relative to the reference data point.

In some embodiments, model evaluation and explanation system 120 uses score decompositions to determine important features a model (or ensemble) that impact scores generated by the model (or ensemble).

In some embodiments, the model evaluation system evaluates and explains the model (or ensemble) by generating score explanation information for a specific score generated by the ensemble model for a particular input data set. In some embodiments, the score explanation information is used to generate Adverse Action information. In some embodiments, the score explanation information is used to generate an Adverse Action letter in order to allow lenders to comply with 15 U.S.C. § 1681 et. seq.

In some embodiments, the model evaluation system 120 evaluates the model (or ensemble) by generating information that indicates whether the model is likely to generate results that disparately impact a protected class. In other embodiments, the model evaluation system evaluates the model (or ensemble) by generating information that allows the operator to determine whether the disparate impact has adequate business justification. Together these allow a lender to substantially comply with the Equal Credit Opportunity Act of 1974, 15 U.S.C. § 1691 et. seq.

In some embodiments, the model evaluation and explanation system (e.g., 120 of FIGS. 1A and 1B) decomposes scores generated by a first model, decompose scores generated by a second model, and compares the decompositions of the first model with the decompositions of the second model. In some embodiments, the first model is a production stage model and the second model is a development stage model, and the model evaluation system monitors the production module by comparing the decompositions of the first model (production model) with the decompositions of the second model (development model). In some embodiments, the model evaluation system uses generated decompositions (as described herein) to monitor a model in production by comparing decompositions gathered in production at an earlier period (e.g., a prior hour, a prior day, a prior week, a prior month, a prior quarter or a prior year) with decompositions from the current period (e.g., this hour, this day, this week, this month, this quarter, this year). In some embodiments, an autoencoder neural network is trained on a prior set of decompositions, and caused to predict new decompositions; when the MSE of the auto-encoder's decompositions on a subset of recent decompositions exceeds a threshold computed by a function or provided as a tunable parameter, the model evaluation system generates an alert and provides the alert to the operator device to cause someone to investigate the model anomaly. In some embodiments the alert contains a description of the anomaly by way of decomposition of the autoencoder using the methods described herein.

In some embodiments, the model (e.g., the model used by modeling system 110) is a fixed linear ensemble, for each input data set, the model evaluation system (e.g., 120) evaluates the ensemble model by generating an ensemble decomposition, and the model evaluation system generates the ensemble decomposition by generating a linear combination of the decompositions of each sub-model (e.g., generated by 121 and 122) by determining a product of the decomposition of each sub-model and the ensemble coefficient the sub-model, and determining a sum of each product. For example, for an ensemble model E represented as a linear combination of sub-models M1 and M2, with coefficients C1 and C2 (e.g., E=C₁M₁+C₂M₂), the decomposition of E (e.g., D_{E}) is represented as the linear combination of the decomposition D1 of the sub-models M1 and the decomposition D2 of the sub-model M2, according to the respective ensemble model coefficients C1 and C2 (e.g., D_{E}=C₁D₁+C₂D₂). In some embodiments other ensemble methods are used, for example bagging, boosting, and stacking. These may be decomposed by the model evaluation system (e.g., 120) in a similar way, first by decomposing submodels and then by combining the decompositions of the submodels based on the ensemble equation.

In some embodiments submodel scores are computed based on the same input features (that is, each model receives the same input features). In other embodiments each submodel score is computed based on a subset of the ensemble's input features. In some embodiments the submodel input variables are distinct sets. In some embodiments the submodel input variables are disjoint sets. In other embodiments the submodel input variables are overlapping sets.

In some embodiments, the model evaluation system is not used to explain an ensemble, but to compare two or more models, which may comprise a mixture of tree and differentiable models. This is especially useful if a practitioner wishes to provide consistent explanations of tree and differentiable models for a variety of applications. In some embodiments, these are the same applications as detailed in the Methods Section, e.g., adverse action, disparate impact, feature importance, and model monitoring. In other embodiments, the applications of this technique help with tasks related to the model building or testing development phases, where the behavior of the predicted score output mapped back onto the inputs can be helpful to a modeler to construct a better model, to understand which modeling technique/machine learning algorithm to pursue, or to determine whether submodels under consideration for ensembling represent a diversity of perspectives on the input data.

In some embodiments, the model evaluation system is not used to explain an ensemble or a heterogeneous mixture of different models, but a number of homogeneous models, e.g., a collection of tree models or a collection of differentiable models. For example, Shapley values computed for different tree models may be biased according to different root values of each model. It is therefore helpful to remove the implementation-specific bias to allow for an accurate comparison across the collection of models. The disclosure herein describes such a method.

In some embodiments, the non-differentiable model decomposition module (e.g., 121) is constructed to perform a feature contribution of forests decomposition process. In some embodiments, the feature contribution of forests decomposition process is the process disclosed in “Consistent Individualized Feature Attribution for Tree Ensembles”, available at https://arxiv.org/pdf/1802.03888.pdf, the contents of which are incorporated by reference herein.

In some embodiments, the non-differentiable model decomposition module (e.g., 121) is constructed to perform a tree model decomposition process by determining a feature attribution value (ϕᵢ) (Shapley value) for features of the tree model by performing a process that implements the following equation:

$${φ}_{i} = {\sum }_{S ⊆ N \backslash \{ i \}} \frac{\vert S \vert ! ( M - \vert S \vert - 1 ) !}{M !} [ {f}_{x} ( S ⋃ \{ i \} ) - {f}_{x} ( S ) ] , \qquad Equation ( 1 )$$

wherein ƒₓ(S)=ƒ(hₓ(z′))=E[ƒ(x)|x_{S}], Equation (2),

M is the number of input features, N is the set of input features, S is the set features constructed from superset N. The function ƒ(hₓ(z′)) defines a manner to remove features so that an expected value of f(x) can be computed which is conditioned on the subset of a feature space x_{S}. The missingingness is defined by z′, each zᵢ′ variable represents a feature being observed (zᵢ′=1) or unknown (zᵢ′=0).

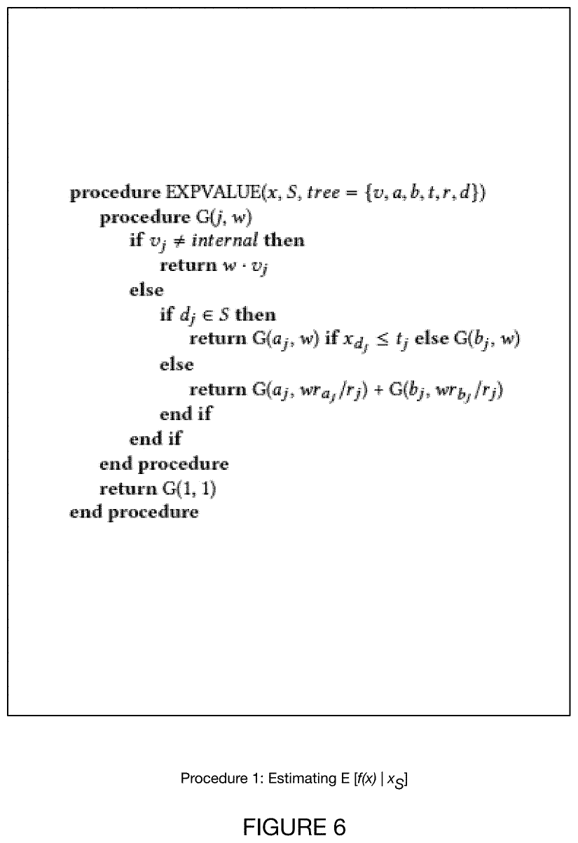

In some embodiments, the non-differentiable model decomposition module estimates E[ƒ(x)|x_{S}] by executing machine-executable instructions that implement the procedure (Procedure 1) shown in FIG. 6, wherein v is a vector of node value, which takes the value internal for internal nodes; the vectors a and b represent the left and right node indexe for each internal node; the vector t contains thresholds for each internal node, and d is a vector of indexes of the features used for splitting in internal nodes; the vector r represent the cover of each node (e.g., how many data samples fall in that sub-tree); the weight w measures what proportion of the training samples matching the conditioning set S fall into each leaf.

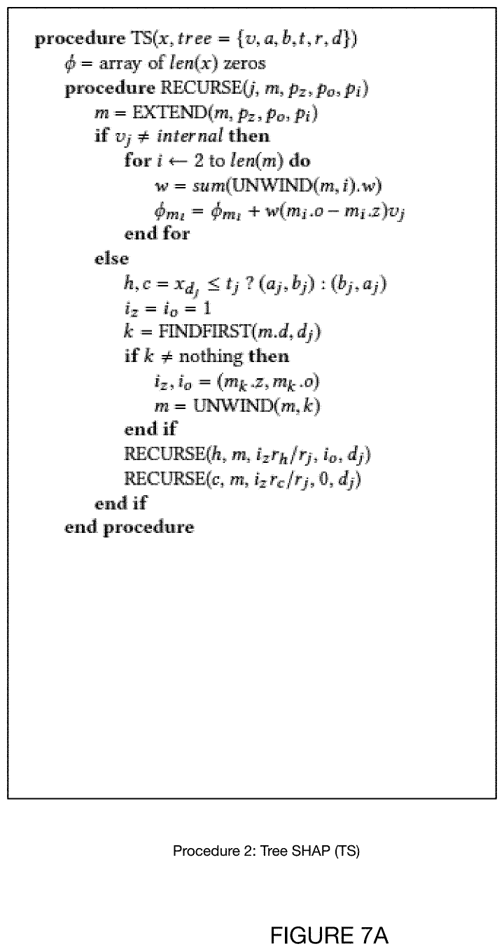

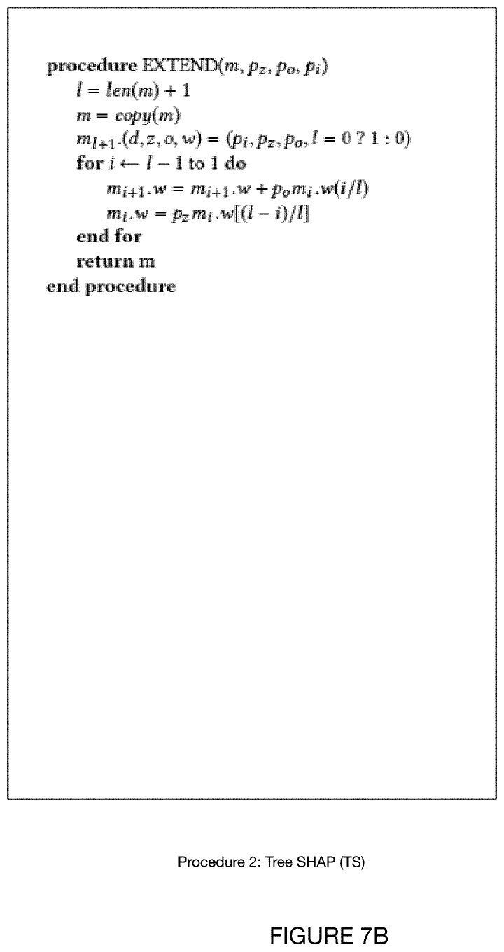

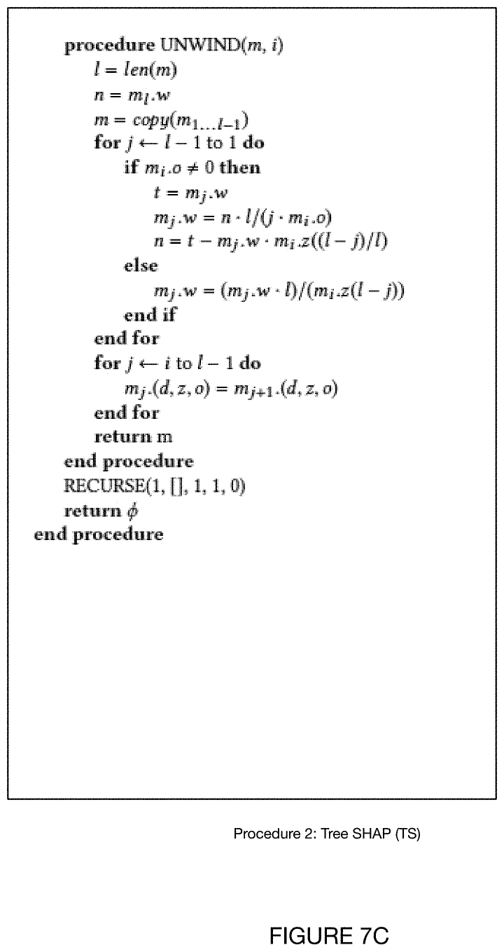

In some embodiments, the non-differentiable model decomposition module estimates E[ƒ(x)|x_{S}] by executing machine-executable instructions that implement Procedure 2, shown in FIGS. 7A-C, wherein v is a vector of node value, which takes the value internal for internal nodes; the vectors a and b represent the left and right node indexe for each internal node; the vector t contains thresholds for each internal node, and d is a vector of indexes of the features used for splitting in internal nodes; the vector r represent the cover of each node (e.g., how many data samples fall in that sub-tree); weight w measures what proportion of the training samples matching the conditioning set S fall into each leaf; m is the path of unique features that have been split on so far; and z is the fraction of “zero” paths (where this feature is not in the set S) that flows through the branch; o is the fraction of “one” paths (where the feature is in the set S) that flow through the branch; and m.d represents a vector of all the feature indexes.

In some embodiments, the evaluated modeling system (e.g., 110) records values for {v, a, b, t, r, d} during scoring of an input data set, and the non-differentiable model decomposition module is constructed to access the recorded values for {v, a, b, t, r, d} from the evaluated modeling system (e.g., via a local network, via the Internet, and the like). In some embodiments, the evaluated modeling system (e.g., 110) records values for w during scoring of an input data set, and the non-differentiable model decomposition module is constructed to access the recorded values for w from the evaluated modeling system. In some embodiments, the non-differentiable model decomposition module is constructed to access a tree structure of a tree model from a storage device. In some embodiments, the non-differentiable model decomposition module is constructed to access a tree structure of a tree model from and the evaluated modelling system.

In some embodiments, the differentiable model decomposition module (e.g, 122) uses integrated gradients, as described by Mukund Sundararajan, Ankur Taly, Qiqi Yan, “Axiomatic Attribution for Deep Networks”, arXiv:1703.01365, 2017, the contents of which are incorporated by reference herein. This process sums gradients at points along a straight-line path from a reference input (x) to an evaluation input (x), such that the contribution of a feature i is given by:

$$( {x}_{i} - {x}_{i}^{′} ) \times {\sum }_{k = 1}^{m} \frac{\partial F ( {x}^{′} \frac{k}{m} \times ( x - {x}^{′} ) )}{\partial {x}_{i}} \times \frac{1}{m}$$

for a given m, wherein xᵢ is the variable value of the input variable i in the evaluation input data set x, wherein xᵢ′ is the input variable value of the input variable i in the reference input data set, wherein F is the model.

Shapley Values and Tree Model Decompositions

In some embodiments, a Shapley value decomposition (e.g., generated by the non-differentiable model decomposition module) is a linear combination of feature attribution values ϕᵢ (Shapley value). In some embodiments, each Shapley value (feature attribution value) is computed by using the Equations 1 and 2. In some embodiments, Shapley value decompositions are SHAP (SHapley Additive exPlanation) values as described in “Consistent Individualized Feature Attribution for Tree Ensembles”. SHAP values explain the output of a model ƒ as a sum of the effects ϕᵢ of each feature being introduced into a conditional expectation. In some embodiments, the decompositions generated by the non-differentiable model decomposition module 121 are SHAP values. In some embodiments, the decompositions determined by the non-differentiable model decomposition module 121 for tree model scores are SHAP values.

In some embodiments, the non-differentiable model decomposition module is constructed to determine at least one Shapley value.

In some embodiments, each decomposition determined by the non-differentiable model decomposition module for tree model score is a linear combination of Shapley values ϕᵢ, wherein each Shapley value is computed by using the Equations 1 and 2. In some embodiments, this linear combination is a SHAP value.

In some embodiments, each decomposition determined by the non-differentiable model decomposition module for a tree model score is a difference between a linear combination of feature attribution values ϕᵢ (Shapley values) for test data points (of an evaluation input data set) and a linear combination of feature attribution values ϕᵢ (Shapley values) for reference data points (of a reference input data set), wherein each feature attribution value is computed by using the Equations 1 and 2. In some embodiments, each linear combination is a SHAP value.

Shapley Values

Pioneered by Lloyd Shapley, Shapley values provide solutions to cooperative games. Such solutions to cooperative games generally attempt to answer the question: Given a group of players, who collaborate to achieve a desirable outcome, how can the overall benefit obtained be optimally distributed among the players? For example, in professional sport clubs, a team works together to score points while simultaneously preventing their opponent from scoring. As better team performance leads to revenue generation, the team manager must decide how to compensate each player based on how they contributed to the success of the team. In theory, Shapley values ϕᵢ can be computed for each player as:

$${φ}_{i} ( f ) = {\sum }_{S ⊆ N \backslash \{ i \}} \frac{\vert S \vert ! ( \vert N \vert - \vert S \vert - 1 ) !}{\vert N \vert !} ( f ( S ⋃ \{ i \} ) - f ( S ) )$$

where S is a coalition of players, N is the number of total players, ƒ(S) is the worth of coalition S, e.g., the value that a particular group of players (defined by S) can achieve. Therefore, the function, ƒ(S) maps a set of players (a coalition) and returns a score. This implies that this mapping function is computed to evaluate different combinations of players to understand the contribution of each individual. Note that the summation of S⊆N{i} includes every possible coalition that can be formed from the set of players that excludes the current player under evaluation. For example, in a team of three players {A, B, C}, if computing ϕ_{c}, the following coalitions exist: {A, B}, {A}, {B}, {(}. In simplified terms, the Shapley value for a given player computes the average marginal benefit that the player adds to each coalition.

In some embodiments, the non-differentiable model decomposition module 121 is constructed to determine at least one Shapley value to decompose the scores obtained by tree-based models, where the input features represent the players, the model prediction scores represent the “benefit”, and the tree-based learner is used to construct an appropriate mapping function. In some embodiments, the non-differentiable model decomposition model is constructed to communicate with the modelling system 110 (e.g, via a local network, the Internet, and the like) to determine each Shapley value. In some embodiments, the task of defining ƒ(⋅) is performed by the non-differentiable model decomposition model 121 by communicating with the modelling system 110 to retrain the model (of the modelling system 110) with the given set of features, and iterating over the Shapley summation given above. For example, if a model used two features x₁ and x₂ and a prediction of x₁=α, x₂=β was to be decomposed, to compute ϕₓ_{₂}, the following models would be trained: M₁ with features x₁ and x₂, M₂ with features x₂, and M₃ with the null set. In some embodiments, the null set model returns the expected value over all training data. In some embodiments, during the marginal difference computation, two iterations are performed, S={x₁} and S={Ø}. In some embodiments, for S={x₁}, the following expression is evaluated: e₁=ƒ({x₁,x₂})−ƒ({x₂}), where ƒ({x₁,x₂}) returns the prediction from model M₁ for the observation x₁=α, x₂=β, and ƒ({x₂}) returns the prediction from model M₂ for the observation x₂=β. In some embodiments, for S={Ø}, the following expression is evaluated: e₂=ƒ({x₂})−ƒ({Ø}, where ƒ({x₂}) returns the prediction from model M₂ for the observation x₂=β, and ƒ({Ø} returns the expected value over the training set. The non-differentiable model decomposition model then computes the Shapley value ϕ₂ by applying the Shapley value equation, e.g., ϕₓ_{₂}(ƒ)=½(e₁+e₂), as N=2, |S|=1.

In some embodiments, training models for each evaluation of ƒ(⋅) is not performed. In some embodiments, the non-differentiable model decomposition module estimates the predicted value of the model (of the modelling system 110), conditioned on the subset of features that form the coalition, e.g., an approximation had the ‘missing’ input features not been available during model train time. In some embodiments, the non-differentiable model decomposition module performs this process by performing at least one of the Procedure 1 and the Procedure 2, disclosed herein, which provide computationally efficient means of computing Shapley values and enable their practical application for the task of decomposing machine learning models, including credit underwriting models composed of tree models, including: decision trees, CART, random forest, and gradient boosted trees.

Integrated Gradients and Differentiable Model Decompositions

In some embodiments, each decomposition determined by the differentiable model decomposition module for differentiable model score is a linear combination of determined products for each feature i of the evaluation input data set, as described herein.

In some embodiments, each decomposition determined by the differentiable model decomposition module for differentiable model score is a linear combination of decomposition values dᵢ for each feature i of the evaluation input data set, as described herein.

In some embodiments, each decomposition determined by the differentiable model decomposition module is a decomposition for test data points (of an evaluation input data set) relative to reference data points (of a reference input data set). In some embodiments, the for an ensemble model that includes both a tree model and a differentiable model, the reference data points used by the differentiable model decomposition module are the same reference data points used by the tree model decomposition module. By using a same set of reference data points, decompositions of tree models and differentiable models of an ensemble model can be combined to generate a decomposition for the ensemble model.

### 2. SYSTEMS

FIGS. 1A-B are a schematic representations of a system 100, according to embodiments. In some embodiments, the system 100 includes a model evaluation system 120 and a modeling system 110 that is to be evaluated by the model evaluation system 120. FIG. 1B depicts exemplary API requests and responses between the model evaluation system 120 and the modeling system 110, and exemplary requests and responses between the evaluation module 123 and the differentiable model decomposition module 122 and the non-differentiable model decomposition module 121.

In some embodiments, the model evaluation system (e.g., 120 of FIGS. 1A-B) includes a non-differentiable model decomposition module (e.g., 121 of FIGS. 1A-B), a differentiable model decomposition module (e.g., 122 of FIGS. 1A-B), and an evaluation module (e.g., 123 of FIGS. 1A-B). In some embodiments, the model evaluation system 120 includes an API (Application Programming Interface) module. In other embodiments, the model evaluation system 120 includes modules that implement black box evaluation methods such as permutation importance.

In some embodiments, the model evaluation system (e.g., 120 of FIGS. 1A-B) includes a differentiable model decomposition module (e.g., 122 of FIGS. 1A-B), and an evaluation module (e.g., 123 of FIGS. 1A-B). In some embodiments, the model evaluation system 120 includes an API (Application Programming Interface) module. In some embodiments, the modeling system 110 includes a non-differentiable model decomposition module (e.g., a decomposition module similar to the non-differentiable model decomposition module 121)

In some embodiments, the model evaluation system 120 is communicatively coupled to a modeling system (e.g., 110 of FIGS. 1A-B). In some embodiments, the model evaluation system 120 is communicatively coupled to an external modeling system (e.g., 110 of FIGS. 1A-B) via a public network. In some embodiments, the model evaluation system 120 is communicatively coupled to a modeling system via a private network. In some embodiments, the model evaluation system is included in a modeling system. In some embodiments, the model evaluation system is communicatively coupled to an external modeling system via an API module of the model evaluation system. In some embodiments, the model evaluation system is communicatively coupled to an external modeling system via an API module of the modeling system. In some embodiments, the model evaluation system 120 and the modeling system are both included in a machine learning platform system.

In some embodiments, the model evaluation system 120 is communicatively coupled to an operator device 171.

In some embodiments, the model evaluation system 120 is communicatively coupled to a storage device 181 that includes input data sets.

In some embodiments, the model evaluation system 120 is communicatively coupled to a storage device 182 that includes modeling system information for the modeling system 110.

### 3. METHODS: MODEL SCORE EXPLANATION FOR AN EVALUATION INPUT DATA SET

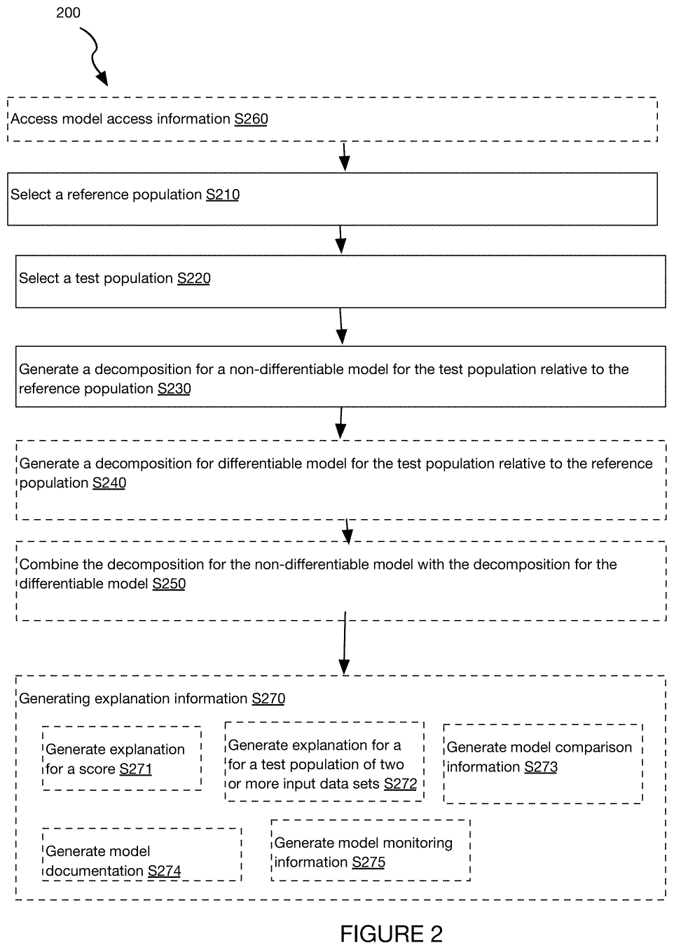

FIG. 2 is a representation of a method, according to embodiments. In some embodiments, the method 200 of FIG. 2 is performed by the model evaluation system 120 of FIGS. 1A-B.

In some embodiments, the method 200 includes: selecting a reference population of one or more reference data points (data sets) S210; selecting a test population of one or more test data points (data sets) S220; and generating a decomposition for a non-differentiable model for the test population relative to the reference population S230. In some embodiments, the non-differentiable model is a credit risk model. In some embodiments, the non-differentiable model is a sub-model of an ensemble. In some embodiments, the ensemble is a credit risk model.

In some embodiments, the method 200 includes at least one of: accessing model access information S260; generating a decomposition for a differentiable model for the test population relative to the reference population S240; combining the decomposition for the non-differentiable model with the decomposition for the differentiable model S250; and generating explanation information S270.

In some embodiments, S210 includes receiving reference population selection information from the modeling system (e.g., 110 of FIGS. 1A-B) (e.g., via one or more remote procedure calls, one or more local procedure calls, an API of the modeling system, an API of the model evaluation system). In some embodiments, S210 includes receiving reference population selection information from the operator device via at least one of a user interface of the model evaluation system 120 and an API of the model evaluation system 120. In some embodiments, S210 includes accessing reference population selection information from a storage device. In some embodiments, the reference population selection information identifies the reference population. In some embodiments, the reference population selection information identifies information (e.g., parameters, constraints, expressions, functions, etc.) used by the model evaluation system 120 to select the reference population. In some embodiments, S210 includes selecting the reference population based on the reference population selection information.

In some embodiments, S220 includes receiving test population selection information from the modeling system (e.g., 110 of FIGS. 1A-B) (e.g., via one or more remote procedure calls, one or more local procedure calls, an API of the modeling system, an API of the model evaluation system). In some embodiments, S220 includes receiving test population selection information from the operator device via at least one of a user interface of the model evaluation system 120 and an API of the model evaluation system 120. In some embodiments, S220 includes accessing test population selection information from a storage device. In some embodiments, the test population selection information identifies the test population. In some embodiments, the test population selection information identifies information (e.g., parameters, constraints, expressions, functions, etc.) used by the model evaluation system 120 to select the test population. In some embodiments, S220 includes selecting the test population based on the test population selection information.

In some embodiments, S220 includes selecting an input data set scored by the modeling system 110 as the test population. In some embodiments, S220 includes selecting input data sets for a protected class as the test population. In some embodiments, S220 includes selecting input data sets of a first time period as the test population.

In some embodiments, S210 includes selecting input data sets to be compared with an input data set selected at S220. In some embodiments, S220 includes selecting an input data set of a denied credit applicant and S210 includes selecting input data sets of approved credit applicants. In some embodiments, S210 includes selecting input data sets for a reference population to be compared with a protected class population selected at S220. In some embodiments, the input data sets for the reference population represent White Non-Hispanic credit applicants. In some embodiments, S210 includes selecting input data sets of a second time period to be compared with input data sets selected at S220, which relate to a first time period.

In some embodiments, a monitoring system selects the reference population at S210 and the test population at S220. In some embodiments, the monitoring system is included in the modeling system 110. In some embodiments, the monitoring system is included in the evaluation system 120. In some embodiments, the monitoring system is included in the operator device 171. In some embodiments, the monitoring system performs monitoring the modelling system 110 over time by periodically selecting reference populations (S210) and test populations (S220) representing first and second time periods to be compared, and controlling the model evaluation system to generate model monitoring information (S275) that compares operation of the model in the first time period with operation of the model in the second time period.

In some embodiments, the method 200 includes: mapping at least one decomposition generated by the method 200 to a score space of a model corresponding to the decomposition.

In some embodiments, mapping at least one decomposition generated by the method 200 to a score space of a model corresponding to the decomposition includes: accessing a model result for the test data point corresponding to the decomposition, and mapping the decomposition to the model result. In some embodiments, accessing the model result includes using the model to generate the model result. In some embodiments, mapping at least one decomposition generated by the method 200 to a score space of a model corresponding to the decomposition includes: determining a test data point that represents the test population used to generate the decomposition, using the model to generate a model result for the determined test data point, and mapping the decomposition to the model result.

In some embodiments, each decomposition generated by the method 200 is a vector of decomposition values dᵢ for each feature. In some embodiments, mapping a decomposition to a score space of the model includes: determine the sum (Sum) of the decomposition values dᵢ, and for each decomposition value dᵢ, dividing the decomposition value by the Sum and multiplying the resulting quotient by a post-sigmoid prediction score (e.g., S(x)) for the corresponding point x (e.g., test data point, reference data point) (e.g., Di_{mapped}=[dᵢ/Sum]*S(x), where

$$S ( x ) = \frac{1}{1 + {e}^{- x}} . )$$

In some embodiments, S270 includes generating explanation information for a score of a single test data point relative to the reference population by using at least one decomposition generated by the method 200, as described herein (e.g., Adverse Action information, as described herein) (S271).

In some embodiments, S270 includes generating explanation information for a plurality of test data points (represented of a test population, e.g., a protected class) relative to the reference population (e.g., fairness information, Disparate Impact information, as described herein) by using at least one decomposition generated by the method 200, as described herein (S272).

In some embodiments, S270 includes generating model comparison information S273. In some embodiments, S273 includes comparing at least a decomposition generated by performing the method 200 for the non-diffentiable model (or an ensemble that includes the non-differentiable model) with a decomposition generated by performing the method 200 for a different model (or ensemble), the comparison of the decompositions being used to generate the model comparison information.

In some embodiments, S270 includes generating model documentation, by using at least one decomposition generated by the method 200, as described herein (S274).

In some embodiments, S270 includes generating model monitoring information, by using at least one decomposition generated by the method 200, as described herein (S275)

In some embodiments, S210 includes selecting a single test data point (e.g., an input data set whose score/output generated by at least the non-differentiable model is to be explained). In some embodiments, the test data point represents a credit applicant. In some embodiments, the test data point represents a test data point at a first point in time. In some embodiments, S210 includes selecting a plurality of test data points having common attributes (e.g., test data points corresponding to members of a protected class of people being evaluated based on score/output generated by at least the non-differentiable model). In some embodiments, the selected test data points represent test data points at a first point in time. In some embodiments, the plurality of test data points represent a protected class population.

In some embodiments, S220 includes selecting a single reference data point that represents the reference population (e.g., a reference data point having feature values that represent average values across the reference population). In some embodiments, the single reference data point represents average feature values of applicants who were “barely approved” (e.g., the bottom 10% of an approved population), according to their credit score. In some embodiments, the reference data point represents a reference data point at a second point in time. In some embodiments, S220 includes selecting a plurality of reference data points for the reference population. In some embodiments, the plurality of reference data points a population to be compared with the protected population to determine at least one of model fairness or disparate impact attributes of the non-differentiable model (or an ensemble that includes the non-differentiable model). In some embodiments, the selected reference data points represent points at a second point in time.

In some embodiments, each decomposition generated by the method 200 (e.g., at S230, S240, S250) is a vector of decomposition values dᵢ for each feature used by the respective model. In some embodiments, each non-differentiable decomposition value (generated at S230) is a difference between a SHAP (SHapley Additive exPlanation) value for a test data point (e.g., a test data point representing a credit applicant, a test data point at a first point in time, etc.) of the test population and a SHAP value for a reference data point of the reference population (e.g., a reference data point representing an accepted credit applicant, a reference data point at a second point in time). In some embodiments, each non-differentiable decomposition value is a difference between a SHAP value for a test data point generated by using the test population (e.g., a protected class population, a test population for a first point in time, etc.) and a SHAP value for a reference data point generated by using the reference population (e.g., a reference population to be compared with the protected class population, a reference population for a second point in time, etc.) (e.g., in a test population to reference population comparison). In some embodiments, each non-differentiable decomposition value is a difference between a SHAP value for a test data point (e.g., a test data point representing a credit applicant, a test data point at a first point in time, etc.) of the test population and SHAP value for a reference data point generated by using the reference population (e.g., a reference population to be compared with the protected class population, a reference population for a second point in time, etc.) (e.g., in a test data point to reference population comparison). In some embodiments, each SHAP value is computed in accordance with Equations 1 and 2.

S230 can include: for each test data point, transforming SHAP attributions for each feature of the test data point (which are model-based attributions) to reference-based attributions (that are computed with respect to the reference population of data sets selected at S210).

In some embodiments, the non-differentiable model at S230 is a tree model. In some embodiments, the non-differentiable model at S230 is included in an ensemble of two or more models.

In some embodiments, the decomposition generated at S240 is a vector of decomposition values for each feature used by the differentiable model. In some embodiments, each decomposition value is differentiable decomposition value dᵢ. In some embodiments, each decomposition value dᵢ is computed in accordance with Equation 3. In some embodiments, each decomposition value dᵢ is computed by performing an integrated gradients process, as described herein.

S240 can include: for each test data point, determining a decomposition for the test data point relative to a corresponding reference data point by using an integrated gradients decomposition process (as described herein).

In some embodiments, the differentiable model at S240 is a continuous model. In some embodiments, the differentiable model at S240 is a neural network model. In some embodiments, the non-differentiable model at S230 is included in an ensemble that includes the non-differentiable model of S230.

In some embodiments, S250 includes combining the decomposition for the non-differentiable model with the decomposition for the differentiable model by using an ensembling function of an ensemble that includes the non-differentiable model and the differentiable model. In some embodiments, the ensemble is a linear combination of at least the non-differentiable model and the differentiable model, and the assembling function identifies a coefficient for the non-differentiable model and a coefficient for the differentiable model, and the decomposition for the non-differentiable model is combined with the decomposition for the differentiable model in accordance with the linear combination.

The method 200 can include: S260, which functions to use the model evaluation system (e.g., 120 of FIGS. 1A-B) to access model access information. In some embodiments, S260 includes accessing model access information for the non-differentiable model of S230. In some embodiments, S260 includes accessing model access information for the differentiable model of S240. In some embodiments, S260 includes accessing the ensembling function of S250.

In some embodiments, S260 includes accessing model access information for a set of sub-models and a corresponding ensembling function of an ensemble model of the modeling system. In some embodiments, at S260, the model evaluation system 120 accesses the model access information from the modeling system (e.g., 110 of FIGS. 1A-B) (e.g., via one or more remote procedure calls, one or more local procedure calls, an API of the modeling system, an API of the model evaluation system). In some embodiments, the model evaluation system 120 accesses the model access information from a storage device (e.g., 182 of FIGS. 1A-B).

In some embodiments, the model access information is used to select the reference population at S210. In some embodiments, the model access information is used to select the test population at S220.

In some embodiments, the model access information for a model (or sub-model of an ensemble) includes information for accessing input data sets for a reference population. In some embodiments, the model access information for a model (or sub-model of an ensemble) includes information for accessing a score generated by the model for a specified input data set. In some embodiments, the model access information for a a model (or sub-model of an ensemble) includes input data sets for a reference population. In some embodiments, the model access information for a a model (or sub-model of an ensemble) includes scores generated by the sub-model for input data sets of a reference population. In some embodiments, the model access information for a model (or sub-model of an ensemble) includes API information for the model. In some embodiments, the model access information for a a model (or sub-model of an ensemble) includes a URL and corresponding authentication information for accessing input data sets for the model and generating a score for a specified input data set by using the model.

S260 can include: identifying each non-differentiable sub-model and each differentiable sub-model in an ensemble, based on the model access information.

In some embodiments, S230 includes: for each non-differentiable sub-model specified by the model access information (of S260), the model evaluation system 120 determining a decomposition for a sub-model score for an evaluation input data set (x) (test data point) of the test population relative to the reference population.

In some embodiments, S230 includes: the model evaluation system 120 accessing the evaluation input data set from the modeling system 110. In some embodiments, S230 includes: the model evaluation system 120 accessing the evaluation input data set from a storage device (e.g., 181 of FIGS. 1A-B). In some embodiments, S230 includes: the model evaluation system accessing the evaluation input data set and the corresponding sub-model score for each non-differentiable sub-model from the modeling system 110. In some embodiments, S230 includes: for each non-differentiable sub-model of the modeling system 110, the model evaluation system accessing a sub-model score for the evaluation input data set. In some embodiments, S230 includes: the model evaluation system accessing the evaluation input data set, and generating the corresponding sub-model score for each non-differentiable sub-model by accessing the modeling system. In some embodiments, S230 includes: for each non-differentiable sub-model of the modeling system 110, the model evaluation system generating a sub-model score for the evaluation input data set by accessing the modeling system. In some embodiments, S230 includes: for each non-differentiable sub-model specified by the model access information, the model evaluation system determining a decomposition for a sub-model score for the evaluation input data set (x) (test data point) by using the input data sets (reference data points) for the reference population.

In some embodiments, the evaluation module 123 performs the process S250.

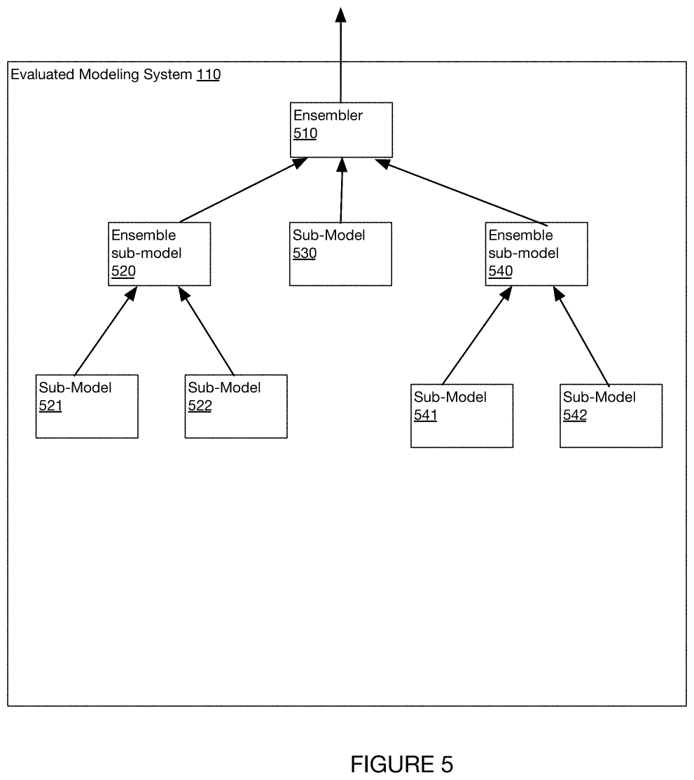

In some embodiments, the non-differentiable model is included in an ensemble model that is a fixed linear ensemble, and the model evaluation system determines a decomposition for the ensemble model score for the evaluation input data set (x) by generating a linear combination of the decompositions of each sub-model by determining a product of the decomposition of each sub-model and the ensemble coefficient of the sub-model, and determining a sum of each product. For example, for an ensemble model E represented as a linear combination of sub-models M1 and M2, with coefficients C1 and C2 (e.g., E=C₁M₁+C₂M₂), the decomposition of E (e.g., D_{E}) is represented as the linear combination of the decomposition D1 of the sub-models M1 and the decomposition D2 of the sub-model M2, according to the respective ensemble model coefficients C1 and C2 (e.g., D_{E}=C₁D₁+C₂D₂). This method can be used on ensembles of ensembles and can be applied to other ensembling methods such as stacking, wherein the submodel coefficients are assigned based on a machine learning algorithm. In some embodiments, at least one sub-model is an ensemble model. In some embodiments, at least one sub-model is a fixed linear ensemble. In some embodiments, at least one sub-model is a stacked ensemble model. In some embodiments, at least one sub-model is a linear model. In some embodiments, at least one sub-model is a bagged ensemble model. In some embodiments, at least one sub-model is a boosted ensemble model. In some embodiments, the ensemble model is a stacked ensemble model. In some embodiments, the ensemble model is a boosted ensemble model. FIG. 5 depicts a modeling system 110 that is an ensemble of ensembles.

In some embodiments, the method 200 includes: the model evaluation system accessing the ensemble model score for the evaluation input data set (test data point) from the modeling system. In some embodiments, the method 200 includes: the model evaluation system generating the ensemble model score for the evaluation input data set by accessing the modeling system.

Non-Differentiable Model Decomposition

In some embodiments, S230 includes: in a case where model is a non-differentiable model (e.g., tree model, discrete model), determining a decomposition for a model score for an evaluation input data set (x) (test data point) relative to the reference population by using a non-differentiable model decomposition module (e.g., 121 of FIGS. 1A-B), as described herein. In some embodiments, the non-differentiable model decomposition module (e.g., 121 of FIGS. 1A-B) accesses a tree structure of the model (tree model) from a storage device (e.g., 182 of FIGS. 1A-B). In some embodiments, the non-differentiable model decomposition module (e.g., 121 of FIGS. 1A-B) accesses a tree structure of the tree model from the modeling system 110, which is communicatively coupled to the model evaluation system via computer network. In some embodiments, the non-differentiable model decomposition module is included in the modeling system 110, and the non-differentiable model decomposition module accesses a tree structure of the tree model. In some embodiments, the tree model is a forest, in other embodiments the tree model is a random forest, in other embodiments, the tree model is a gradient boosted tree.

In some embodiments, the non-differentiable model decomposition module includes machine-executable instructions that when executed determine a decomposition for a tree model by determining a feature attribution value (i) (Shapley value) for features of the tree model by performing a process that implements the following equation:

$${φ}_{i} = {\sum }_{S ⊆ N \backslash \{ i \}} \frac{\vert S \vert ! ( M - \vert S \vert - 1 ) !}{M !} [ {f}_{x} ( S ⋃ \{ i \} ) - {f}_{x} ( S ) ] , \qquad Equation ( 1 )$$

wherein ƒₓ(S)=ƒ(hₓ(z′))=E[ƒ(x)|x_{S}] Equation (2),

wherein M is the number of input features, N is the set of input features, S is the set features constructed from superset N. The function ƒ(hₓ(z′)) defines a manner to remove features so that an expected value of f(x) can be computed which is conditioned on the subset of a feature space x_{S}. The missingingness is defined by z′, each zᵢ′ variable represents a feature being observed (zᵢ′=1) or unknown (zᵢ′=0).

In some embodiments, the non-differentiable model decomposition module includes machine-executable instructions that when executed estimate E[ƒ(x)|x_{S}] by performing process steps that implement Procedure 1 shown in FIG. 6, wherein v is a vector of node value, which takes the value internal for internal nodes; the vectors a and b represent the left and right node index for each internal node; the vector t contains thresholds for each internal node, and d is a vector of indexes of the features used for splitting in internal nodes; the vector r represent the cover of each node (e.g., how many data samples fall in that sub-tree); the weight w measures what proportion of the training samples matching the conditioning set S fall into each leaf.

In some embodiments, the non-differentiable model decomposition module includes machine-executable instructions that when executed estimate E[ƒ(x)|x_{S}] by performing process steps that implement Procedure 2, shown in FIGS. 7A-C, wherein v is a vector of node value, which takes the value internal for internal nodes; the vectors a and b represent the left and right node index for each internal node; the vector t contains thresholds for each internal node, and d is a vector of indexes of the features used for splitting in internal nodes; the vector r represent the cover of each node (e.g., how many data samples fall in that sub-tree); weight w measures what proportion of the training samples matching the conditioning set S fall into each leaf; m is the path of unique features that have been split on so far; and z is the fraction of “zero” paths (where this feature is not in the set S) that flows through the branch; o is the fraction of “one” paths (where the feature is in the set S) that flow through the branch; and m.d represents a vector of all the feature indexes.

In some embodiments, the evaluated modeling system (e.g., 110) records values for {v, a, b, t, r, d} during scoring of an input data set, and the non-differentiable model decomposition module is constructed to access the recorded values for {v, a, b, t, r, d} from the evaluated modeling system (e.g, at S260). In some embodiments, the evaluated modeling system (e.g., 110) records values for w during scoring of an input data set, and the non-differentiable model decomposition module is constructed to access the recorded values for w from the evaluated modeling system (e.g., at S260). In some embodiments, the non-differentiable model decomposition module is constructed to access a tree structure of a tree model from a storage device (e.g., at S260). In some embodiments, the non-differentiable model decomposition module is constructed to access a tree structure of a tree model from and the evaluated modelling system (e.g., at S260). In some embodiments, S260 includes accessing values for {v, a, b, t, r, d} for each tree model. In some embodiments, S260 includes accessing values w for each tree model. In some embodiments, S260 includes accessing a tree structure for each tree model.

In some embodiments, the non-differentiable model decomposition module (e.g., 121 of FIGS. 1A-B) determines a decomposition for a model (or sub-model) by using an allocation defined by Shapley values, a technique from collaborative game theory. Although originally designed to optimally distribute the surplus generated by a coalition of workers, in the case of tree explainability, the ‘surplus’ refers to the model's score and the ‘workers’ refer to the input features. Although Shapley-based decomposition has a number of ideal properties, three are briefly mentioned. First, it is consistent, e.g., the individual attributions will exactly sum to the score produced by the tree. Without consistency, Shapley would be an ill-suited candidate for tree decomposition. Second, it is symmetric, e.g., if two features identically contribute to the model output, both will be given identical numerical weight. This is extremely important for tree-based learners, where two functionally equivalent trees, which have their feature-nodes arbitrarily reordered, may produce different results for decomposition. Lastly, it preserves nullity, e.g., features that have no impact on the model receive values of zero.

In some embodiments, the non-differentiable model decomposition module 121 includes machine-executable instructions that when executed perform process steps that implement the decomposition technique presented in “Consistent Individualized Feature Attribution for Tree Ensembles” by Lundberg et. al. By virtue of the foregoing, a computationally tractable solution for computing Shapley values on hardware systems can be provided.

Differentiable Model Decomposition

In some embodiments, S240 includes: determining a decomposition for a model score for an evaluation input data set (x) (test data point) of the test population relative to a reference data point of the reference population by using a differentiable model decomposition module (e.g., 122), as described herein, of the model evaluation system 120. In some embodiments, the differentiable model is a perceptron, a feed-forward neural network, an autoencoder, a probabilistic network, a convolutional neural network, a radial basis function network, a multilayer perceptron, a deep neural network, or a recurrent neural network, including: Boltzman machines, echo state networks, long short-term memory (LSTM), hierarchical neural networks, stochastic neural networks, and other types of differentiable neural networks, without limitation.

In some embodiments, S240 includes: for each feature i of the evaluation input data set (test data point): selecting at least one value along the straight line path from the value xᵢ of feature i of the evaluation input data set (test data point) to the value x′ᵢ of the feature i of the reference input data set (reference data point); determining a derivative of the differentiable model for each selected value of the feature i along the straight line path; determining a sum of the derivatives; and determining a product of the determined sum and a difference between the value xᵢ of feature i of the evaluation input data set and the value x′ᵢ of the feature i of the reference input data set, wherein the decomposition is a vector that includes the determined products for each feature i of the evaluation input data set. In some embodiments, a plurality of values along the straight line path are selected at an interval m, and the value of each determined product is divided by m.

In some embodiments, the model evaluation system 120 determines each derivative of the differentiable model for each selected value of each feature i. In some embodiments, the model evaluation system 120 uses the modeling system 120 to determine each derivative of the differentiable model for each selected value of each feature i. In some embodiments, the model evaluation system 120 uses the modeling system 120 to determine each derivative of the differentiable model for each selected value of each feature i via an API of the modeling system 110. In some embodiments, the API is a REST API. In some embodiments, the API is an API that is accessible via a public network. In some embodiments, the API is an API that is accessible via an HTP protocol. In some embodiments, the API is an API that is accessible via a remote procedure call.

In some embodiments, the model evaluation system 120 determines each derivative of the differentiable model for each selected value of each feature i by using a gradient operator to determine the derivatives for each selected value. In some embodiments, the model evaluation system 120 uses the modeling system 120 to determine each derivative of the differentiable model for each selected value of each feature i by using a gradient operator of the modeling system 120.

In some embodiments, generating the decomposition of the evaluation input data set relative to the reference input data set includes, for each feature i of the evaluation input data set: determine a set of values v between the value xᵢ of feature i of the evaluation input data set and the value x′ᵢ of the feature i of the reference input data set (e.g, v=(xᵢ+(k/m)(xᵢ−x′ᵢ)), for 1<=k<=m,); determining a derivative of the sub-model for each determined value v (e.g.,

$$\frac{\partial F ( v )}{\partial {x}_{i}} = \frac{\partial F ( {x}^{′} + \frac{k}{m} \times ( x - {x}^{′} ) )}{\partial {x}_{i}}$$

for 1<=k<=m), for sub-model F); determining a sum of the derivatives

$$( {\sum }_{k = 1}^{m} \frac{\partial F ( {x}^{′} + \frac{k}{m} \times ( x - {x}^{′} ) )}{\partial {x}_{i}} ) ;$$

determining a product of the determined sum and a difference between the value xᵢ of feature i of the evaluation input data set and the value x′ᵢ of the feature i of the reference input data set

$$( e . g . , ( {x}_{i} - {x}_{i}^{′} ) \times {\sum }_{k = 1}^{m} \frac{\partial F ( {x}^{′} + \frac{k}{m} \times ( x - {x}^{′} ) )}{\partial {x}_{i}} ) ;$$

and determining a decomposition value dᵢ for the feature i by dividing the determined product for feature i by m (e.g.,

$$( {x}_{i} - {x}_{i}^{′} ) \times {\sum }_{k = 1}^{m} \frac{\partial F ( {x}^{′} + \frac{k}{m} \times ( x - {x}^{′} ) )}{\partial {x}_{i}} \times \frac{1}{m} ) ,$$

wherein the decomposition a linear combination (or vector) that includes the determined decomposition values dᵢ for each feature i of the evaluation input data set (e.g, decomposition=d_{I}+dᵢ+ . . . +dₙ).

In some embodiments, the differentiable model decomposition module (e.g, 122) performance an integrated gradients process, as described by Mukund Sundararajan, Ankur Taly, Qiqi Yan, “Axiomatic Attribution for Deep Networks”, arXiv:1703.01365, 2017, the contents of which are incorporated by reference herein, to determine a decomposition for a differentiable model score (for a differentiable model) for the evaluation input data set (x). This process sums gradients at points along a straight-line path from a reference input (x) to an evaluation input (x), such that the contribution of a feature i is given by:

$$( {x}_{i} - {x}_{i}^{′} ) \times {\sum }_{k = 1}^{m} \frac{\partial F ( {x}^{′} + \frac{k}{m} \times ( x - {x}^{′} ) )}{\partial {x}_{i}} \times \frac{1}{m}$$

for a given m, wherein xᵢ is the variable value of the input variable i in the evaluation input data set x, wherein xᵢ′ is the input variable value of the input variable i in the reference input data set, wherein F is the model.

In some embodiments, the differentiable model decomposition module (e.g, 122) performs the integrated gradients process by using Advanced quadrature methods described herein. In some embodiments, the differentiable model decomposition module (e.g, 122) performs the integrated gradients process by using Adaptive quadrature methods described herein.

Generating a Reference Input Data Set (Reference Data Point)

In some embodiments, S210 includes: generating a reference input data set (reference data point) representative of the reference population. In some embodiments, S210 includes: selecting a reference population from training data (e.g., of the modelling system 110); for each numerical feature represented by the input data sets (reference data points) of the reference population, determining an average value for the feature from among the feature values of the input data sets of the reference population; for each categorical feature represented by the input data sets of the reference population, determining a mode value for the feature from among the feature values of the input data sets of the reference population; wherein the reference input data set (reference data point) includes the average feature values as the features values for the numerical features and the mode feature values as the features values for the categorical features.

Decomposition Using a Reference Population without Pre-Computing Reference Input Data Set

In some embodiments, S230 includes: for each input data set (reference data point) of the reference population, using the non-differentiable model decomposition module to, for each input data set (reference data point) of the reference population, generate a decomposition of the evaluation input data set (x) (test data point) relative to the reference data point; for each feature represented by the decompositions relative to the reference data points, determine a feature average among the feature values of the decompositions relative to the reference data points to generate a decomposition of the test data point relative to the reference population. In some embodiments, the decomposition of the test data point to the reference population is a linear combination (or vector) of the feature averages. In some embodiments features with categorical values are encoded as numerics using a suitable method such as one-hot encoding or another mapping specified by the modeler.

In some embodiments, S240 includes: for each input data set (reference data point) of the reference population, using the differentiable model decomposition module to, for each input data set (reference data point) of the reference population, generate a decomposition of the evaluation input data set (x) (test data point) relative to the reference data point; for each feature represented by the decompositions relative to the reference data points, determine a feature average among the feature values of the decompositions relative to the reference data points to generate a decomposition of the test data point relative to the reference population. In some embodiments, the decomposition of the evaluation input data relative to the reference population is a linear combination (or vector) of the feature averages. In some embodiments features with categorical values are encoded as numerics using a suitable method such as one-hot encoding or another mapping specified by the modeler.

In some embodiments, the reference population selected at S210 is a subset of a larger population.

Decomposition of Ensemble and Non-Ensemble Models

In some embodiments, the model being evaluated by the method 200 is a linear ensemble of a plurality of models (e.g., the non-differentiable model of S230 and the differentiable model at S240), each model being a non-differentiable model (e.g., tree model) or differentiable model. In some embodiments a non-differentiable model in the ensemble is a gradient boosted tree. In other embodiments a non-differentiable model in the ensemble is a random forest, a decision tree, a regression tree, or other tree model or equivalent stochastic rule-set. In some embodiments a differentiable model in the ensemble is a linear model. In other embodiments a differentiable model in the ensemble is a polynomial, a perceptron, a neural network, a deep neural network, a convolutional neural network, or recurrent neural network such as LSTM. In some embodiments a neural network in the ensemble uses the relu activation function, in other embodiments a neural network in the ensemble uses the sigmoid activation function, and further embodiments use other computable activation functions.

In some embodiments, the model evaluated by the method 200 is not an ensemble of many sub-models, but rather a single model, either of non-differentiable or differentiable model, as described above, and the model evaluation system compares the model to one or more other non-differentiable or differentiable models (of the modelling system 110 or another modelling system) (e.g., at S273). In some embodiments, the model evaluation system 120 compares an ensemble model or single model to a variety of other models, of both single and ensemble types. In some embodiments, there are no constraints placed upon the shared input features sets that are used by the models under consideration. For example, model A uses feature set a and model Buses feature set b; the sets may be identical (a=b), the sets may be disjoint (a∩b=0), the sets may be subsets of one another (a⊆b or b⊆a), or the sets may share similar features (a∩b≠0, a∩b≠a∪b).

Applications of Decomposition

In some embodiments, the model evaluation system uses a decomposition generated for a model score (e.g., at one or more of S230, S240, S250) to generate feature importance information and provide the generated feature importance information to the operator device 171. Feature importance is the application wherein a feature's importance is quantified with respect to a model. A feature may have significant or marginal impact, and it could hurt or harm how a model will score. Features may be colinear and interact and any feature importance application takes into account interactions and colinearities. The present disclosure describes such a method.

In some embodiments, the model evaluation system uses a decomposition generated for a model score to generate adverse action information (e.g., at S271) (as described herein) and provide the generated adverse action information to the operator device 171.

In some embodiments, the model evaluation system uses a decomposition generated for a model score to generate disparate impact information (e.g., at S272) (as described herein) and provide the generated disparate impact information to the operator device 171.

In some embodiments, the decomposition techniques described herein are used for understanding the influence of a particular feature across a range of values for that feature for a given population, also known as feature influence, which is roughly equivalent but offers greater insight than partial dependence plots. For reference, partial dependence plots attempt to demonstrate the “averaged” effect upon the predicted output of a specific feature over it's input range (continuous) or space (categorical) by providing a line plot. Decomposition for feature influence provides a plot with increased fidelity; rather than a line plot, the actual distribution of points is provided, offering additional insight. In some embodiments the model evaluation system 120 receives a model and generates a decomposition for feature influence plot which is provided to the operator device 171.

In some embodiments, the model evaluation system 120 uses generated decompositions (as described herein) to monitor a model in production by comparing decompositions gathered in production with decompositions generated during model development and evaluation (e.g., at S275). In some embodiments, the model evaluation system uses generated decompositions (as described herein) to monitor a model in production by comparing decompositions gathered in production at an earlier period (e.g., a prior hour, a prior day, a prior week, a prior month, a prior quarter or a prior year) with decompositions from the current period (e.g., this hour, this day, this week, this month, this quarter, this year). In some embodiments, an autoencoder neural network is trained on a prior set of decompositions, and caused to predict new decompositions; when the MSE of the auto-encoder's decompositions on a subset of recent decompositions exceeds a threshold computed by a function or provided as a tunable parameter, the model evaluation system 120 generates an alert and provides the alert to the operator device 171 to cause someone to investigate the model anomaly. In some embodiments the alert contains a description of the anomaly by way of decomposition of the autoencoder using the methods described herein.

In some embodiments, the model evaluation system 120 uses generated decompositions (as described herein) to generate lower-level interpretations of ensembled models, and provide the lower-level interpretations to the operator device 171. Traditionally, ensembling sub-models reduces the inherent bias of a particular sub-model, e.g., mixed learner type, mixed hyper-parameters, mixed input data, by combining several sub-models that work in concert to generate a single output score. Generally, when data practitioners seek to contrast the behavior of the sub-models against the joint ensembled model, they are relegated to higher-level population statistics that often measure some accuracy metric that lacks a certain amount of fidelity, e.g., “ensembling two mediocre models resulted in a model that outperforms its substrates in nearly all circumstances.” Conversely, decomposition offers lower-level detailed explanations of a given observation or a population of how the features (which are overlapping between any two or more sub-models) interact. These interactions provide value and may demonstrate weak and strong directional interactions on a feature-basis between the various sub-models. For example, given a population and an ensemble of two sub-models with consistent feature inputs, certain features may routinely create strong and positive influences for both sub-models (constructive interference), while other features may routinely create strong and positive influences in one sub-model but be counteracted by strong and negative influences by the other (destructive interference).

In some embodiments, the model evaluation system 120 associates a generated decomposition with the corresponding model within a knowledge graph of the model evaluation system (e.g., at S274), wherein the knowledge graph contains nodes, attributes, and labeled edges describing the model variables, the model, a machine-readable representation of the model's computational graph, modeling methods used, training and test data, attributes of training and test data including date ranges and provenance, feature engineering methods, test descriptions including results, hyperparameters, AUC charts, hold out sets, swap-set analysis, economic impact analysis, approval rate analysis, loss projection analysis, ensembling method, data source and provenance, data ranges, a machine-readable description of feature engineering methods, partial dependence plots, or decompositions. In some embodiments model metadata includes a mapping between decompositions and adverse action reason codes. In some embodiments the adverse action mapping is a computable function based on a decomposition. In some embodiments model metadata is stored on a filesystem in a suitable format such as YAML or feather, or in database.

In some embodiments, the knowledge graph is included in the storage device 182.

In some embodiments, the model evaluation system (e.g., 120) provides modeling tools to an operator device (e.g., 171) to perform decompositions. In some embodiments modeling tools collect metadata from the operator device that is associated with a decomposition. In some embodiments, this metadata includes the decomposition, the model or ensemble and metadata, including feature descriptions, source variables and provenance, feature distributions over time, training data, statistics, symbols, natural language descriptions and templates, and other metadata, without limitation.

In some embodiments, the model evaluation system 120 uses model metadata based on decompositions to automatically generate model risk management artifacts and documentation (e.g., at S274). In some embodiments this documentation allows companies to comply with OCC Bulletin 2011-12, Supervisory Guidance on Model Risk Management. In some embodiments the model risk management documentation includes decompostions of models over time, and at decision points in the modeling process. In other embodiments the model risk management documentation includes disparate impact analysis described herein. In other embodiments machine learning model risk management documentation includes decompositions of models under missing data conditions.

In some embodiments the model evaluation system 120 uses model metadata based on decompositions to automatically generate model risk management documentation in relation to the ongoing health of models operating in production. In some embodiments the monitoring method performed by the model evaluation system 120 includes first computing the distribution of decompositions of a model's score in batch, live testing, or production within a given timeframe in the past, and comparing the past distributions with the distribution of decompositions of a model's score with a more recent timeframe. In some embodiments the comparing step includes computing a PSI score or other suitable statistic. In other embodiments the comparing step includes computing influence functions.

In some embodiments the model evaluation system 120 provides modeling tools that use decompositions and model metadata to provide (to the operator device) a workflow to prepare adverse action mappings and to generate adverse action notices based on model scores, in batch and at decision-time.

Configurations for the Test and Reference Populations

In some embodiments, the model evaluation system 120 decomposes a single observation (test pont), T, in terms of another observation (reference data point), R. In the case of consumer credit underwriting, this allows for applicant-to-applicant comparisons; explaining the credit quality of an applicant (test data point), T, in terms of another applicant (reference point), R. In this embodiment, the model evaluation system computes the decomposition of T with respect to R by running the procedure outlined below once, with T as the input test data point and R as the input reference data point. In such applicant-to-applicant comparisons, S210 includes selecting a single test data point and S220 includes selecting a single reference data point.

In some embodiments, the model evaluation system decomposes observations (plural test data points) Tᵢ, where i∈{1, . . . , N} in terms of a single observation (reference data point), R. In the case of consumer credit underwriting, this embodiment allows for group-to-applicant comparisons; explaining the credit quality of a group, Tᵢ, in terms of a single applicant, R. In such group-to-applicant comparisons, S210 includes selecting a plural test data points and S220 includes selecting a single reference data point. In this embodiment, the model evaluation system runs the procedure outlined below N times, once for each unique T as the input test data point and fixed R as the input reference data point. In some embodiments, the model evaluation system use each unique decomposition, e.g., T₁ in terms of R, T₂ in terms of R, etc., to generate explainability information (which the model evaluation system provides to the operator device). In other embodiments, the model evaluation system collapses the set of decompositions such that one aggregate measure, of test data points with respect to the reference data point, is computed. In some embodiments, this is performed by the model evaluation system through the averaging of decomposition values, e.g.,

$$\frac{1}{N} {\sum }_{i} {T}_{i} - R .$$

In some embodiments, the model evaluation system decomposes a single observation (test data point), T, in terms of observations (plural reference data points) Rᵢ, where i∈{1, . . . , N}. In such embodiments, S210 includes selecting a single test data point and S220 includes selecting plural reference data points. In some embodiments, the model evaluation system 120 is constructed to receive user selection of a value N (form the operator device 171) that specifies the number of observations Rᵢ to be used in the decompositions. In some embodiments, the model evaluation system provides the operator device with a suggested value N. In some embodiments, the model evaluation system is constructed to receive parameters from the operator device that the model evaluation system uses to determine when to stop computing additional decompositions with respect to R. In the case of consumer credit underwriting, this allows for applicant-to-group comparisons; this embodiment explains the credit quality of a single applicant, T, in terms of a group, Rᵢ, for example, as is needed to provide adverse action reasons which are further used to generate natural language explanations for mailed consumer notices. In this embodiment, the model evaluation system runs the procedure outlined below N times, once for each unique R as the input reference data point and T as the input test data point. In some embodiments, the model evaluation system uses each unique decomposition, e.g., T in terms of R₁, T in terms of R₂, etc., to generate explainability information (which the model evaluation system provides to the operator device). In other embodiments, the model evaluation system collapses the set of decompositions such that one aggregate measure, of the test data point with respect to the reference data points, is computed. In some embodiments, this is performed by the model evaluation system through the averaging of decomposition values, e.g.,

$$\frac{1}{N} {\sum }_{i} T - {R}_{i} .$$

In some embodiments the model evaluation system selects a random sample \hat{R}⊆Rᵢ such that \hat{N}=|\hat{R}|≤|Rᵢ|, where \hat{N} is a tunable parameter, to reduce the amount of time required to compute the decomposition.

In some embodiments, the model evaluation system decomposes N observations (plural test data points) Tᵢ, where i∈{1, . . . , N} in terms of M observations (plural reference data points) Rⱼ, where j∈{1, . . . , M}. In such embodiments, S210 includes selecting plural test data points and S220 includes selecting plural reference data points. In some embodiments, the model evaluation system is constructed to receive user selection of a value N (form the operator device 171) that specifies the number of observations Rᵢ to be used in the decompositions. In some embodiments, the model evaluation system provides the operator device with a suggested value N. In some embodiments, the model evaluation system is constructed to receive parameters from the operator device that the model evaluation system uses to determine when to stop computing additional decompositions with respect to R. In the case of consumer credit underwriting, this embodiment allows for group-to-group comparisons; explaining the credit quality of a group of applicants, Tᵢ, in terms of another group, Rᵢ, as one may commonly need to perform for disparate impact, or model monitoring. In this embodiment, the model evaluation system run the decomposition procedure M×N times, for each unique T and unique R. In some embodiments, the model evaluation system uses each unique decomposition, e.g., Tᵢ in terms of Rⱼ, to generate explainability information. In other embodiments, model evaluation system collapses the set of decompositions by a statistic such as a mode, rather than retaining M×N decompositions, an aggregate measure is generated for each test data point, thereby collapsing the number of decompositions generated to N. In some embodiments, this is performed by the model evaluation system through averaging,

$$\frac{1}{M} {\sum }_{j} {T}_{i} - {R}_{j} .$$

In other embodiments, the model evaluation system generates an aggregate measure for each reference data point, thereby collapsing the number of decompositions generated to M. In some embodiments, this is performed by the model evaluation system through averaging,

$$\frac{1}{N} {\sum }_{i} {T}_{i} - {R}_{j} .$$

In other embodiments, the model evaluation system collapses the set of decompositions twice, such that a single decomposition is obtained that provides a quantitative measure of how the two observational sets differed. In some embodiments, this is performed by the model evaluation system aggregating over the number of test data points and reference data points, or visa versa as the aggregation technique may be order dependent. In some embodiments, this can be performed by the model evaluation system through the averaging of decomposition values, e.g.,

$$\frac{1}{M N} {\sum }_{i} {\sum }_{j} {T}_{i} - {R}_{j} .$$

In some embodiments, a decomposition is a vector or a set of vectors, each of length equal to the number of input features, and can be reduced to a single dimension. In some embodiments, this can be performed by taking L₁, L₂ or L_{∞} type mathematical norm.

In some embodiments, a decomposition is a set of vectors, each of length equal to the number of input features. In some embodiments, aggregate metrics can be applied to reduce the dimensionality of the vector space. In some embodiments, averages can be used to form a single vector.

In some embodiments, a decomposition is a set of vectors, where the univariate distributions will be of interest. For example, for a given feature, the model evaluation system applies statistical methods, e.g., median, mode, estimation of probability distribution function. In some embodiments, multivariate distributions will be of interest. For example, in the case of bivariate, trivariate, and higher dimensional comparisons, similarity (or divergence) metrics can be applied, e.g., cosine similarity, Wasserstein metric, Kullback-Leibler divergence.

Composition of the Test and Reference Sets

In some embodiments, in the case of an applicant-to-applicant comparison, the applicant of interest composes the test set (test data point) (selected at S220), and the other composes the reference set (reference data point) (selected at S210).

In some embodiments, when applied to adverse action, the model evaluation system 120 evaluates a specific denied credit applicant. In this embodiment the specific denied credit applicant comprises the test set (test data point) (selected at S220), and a representative group comprises the reference set (reference data points) (selected at S210). In some embodiments, the representative group is comprised of applicants who were “barely approved” (e.g., the bottom 10% of an approved population), according to their credit score. In other embodiments, the representative group will be comprised of those applicants who were “approved” (e.g., all of the approved population), according to their credit score. In other embodiments, the representative group will be comprised of the “top approved” applicants (e.g., the best credit applicants), according to their credit score. In some embodiments the credit score is computed by a model. In other embodiments the credit score is computed by a machine learning model.

In some embodiments, when applied to disparate impact, the model evaluation system 120 evaluates all applicants of a protected class. In this embodiment the members of the protected class comprise the test set (test data points) (selected at S220), and all applicants of the non-protected class comprise the reference set (reference data points) (selected at S210). In other embodiments, the union of multiple protected and/or non-protected classes comprises the test and/or reference sets (e.g., all African American and Hispanic applicants comprise the test set).

In some embodiments, when applied to feature importance, the model evaluation system 120 evaluates all applicants. In this embodiment all applicants comprise both the test and reference sets, e.g., each applicant is decomposed in terms of all others.

In some embodiments, in the case of model monitoring, a time window of applicants during live production comprises the test set (selected at S220), and the data used during model train, or a subset thereof, comprises the reference set (selected at S210).

In some embodiments, in the case of model monitoring, the model evaluation system 120 compares decompositions gathered in production at an earlier period (e.g., a prior hour, a prior day, a prior week, a prior month, a prior quarter or a prior year) with decompositions generated during the current period (e.g., this hour, this day, this week, this month, this quarter, this year). In this embodiment the earlier period decompositions comprise the reference set (selected at S210) and the current period decompositions comprise the test set (selected at S220).

In some embodiments, the test and reference sets (selected at S220 and S210, respectively) are representative of particular business-driven classifications, e.g., classification according to specific geographical regions, marketing channels, credit-risk classifications of borrowers, borrower key attribute groups, demographic attributes, personal attributes, protected class membership status, etc., and any combination thereof. Such selections of the test and reference populations provide insight into the main difference drivers in the model results, from an input feature perspective, between any two groups. In other embodiments, the test and reference groups may be the same, e.g., when comparing the feature importance for one geographic segment of the country to another, the data scientist practitioner may run two experiments, where the feature importance, as determined by decomposition described herein, is run for each segment.

In some embodiments, the reference is a vector representing a fixed point. In some embodiments, the reference is a vector representing a zero vector. In some embodiments, the model evaluation system 120 constructs a reference from the selected set of points by applying a computable function (e.g., by averaging values of the selected set of points to compute a centroid). In other embodiments, the reference is a set of vectors, constructed through a similar process (e.g., averaging clusters of points, or traditional clustering through a k-means approach or other suitable method).

In some embodiments, generating a reference data point or set of points from a given reference population may rely upon different techniques depending on the type of input variable, e.g., numerical (float or integer precision), categorical (ordinal or unstructured), and boolean (true or false). In some embodiments, for each numerical feature, selecting an average or median value among the reference population is performed by the model evaluation system. In some embodiments, for each categorical, the median or mode value is selected for ordinals and the mode is selected for unstructured categoricals. In some embodiments, for each boolean, the mode value is selected. In some embodiments the numerical features represent pixels in an image. In some embodiments a color histogram is computed. In some embodiments the categorical variables represent text. In some embodiments an unsupervised dirichlet process modeling algorithm such as LDA is applied to text variables in order to generate numeric vectors.

In some embodiments, a broad class of credit explainability problems, which can be formulated as test and reference sets, with the goal of explaining the differences thereof, implement essentially the same approach.

Axiomatic Similarity Between Tree and Differentiable Techniques

Since this disclosure describes a technique that combines two different approaches of decomposition, e.g., Shapley values for tree-based models and Integrated Gradients for differentiable-models, the axiomatic similarity between these two approaches will be discussed. Such a treatment is not known to the inventors to exist elsewhere. Below, a series of properties are defined to (1) increase likelihood that the resulting implementation accurately and reasonably depicts the true model behavior and (2) limit the infinite space of decomposition-based implementations as to help the development process.

Efficiency; both Shapley and Integrated Gradients methods enforce that the distribution of the decomposition values will sum to the output score. Shapley provides this guarantee by enumerating over all permutations (of feature sets) and computes an allocation that directly satisfies this property. The method of Integrated Gradients provides this guarantee by integrating the gradients along a path between two points, e.g, reference and test. Moreover, the broader family of path integration methods, e.g., the integrated path between two points in a field that has defined first-order gradients, is guaranteed to provide an efficient decomposition.

Symmetry; both Shapley and Integrated Gradient methods enforce that equal weight will be assigned to all (two or more) features that have equal contribution to the predicted model score. Shapley provides this guarantee by enumerating over all permutations (of feature sets, e.g., coalitions) and continually swaps-in/swaps-out each feature to understand the net effect of their individual contributions. The principle justification, in the case of features with identical contributions, is that they will receive equal weight if and only if, after an exhaustive search of permutation space, e.g., marginal benefit of ƒ₁ added to a coalition (compared to the benefit without), for all possible coalitions, their final Shapley values will be identical. In the case of Integrated Gradients, while an infinite number of paths exist (for the path integral), the straight-line path from the reference to test enforces symmetry.

Implementation invariant; both Shapley and Integrated Gradient methods enforce that the decomposed values will be consistent if the underlying models are functionally equivalent. Shapley provides this guarantee by considering all possible re-orderings of the tree structure, such that if a node (feature) re-orderings do not change the model output score, the attributions will not change. This is not true for popular tree walking methods such as Sabbas (see Interpreting machine learning models” Ando Sabbas, http://cs.ioc.ee/˜tarmo/tday-kao/saabas-slides.pdf, Github: https://github.com/andosa/treeinterpreter), which will provide different attribution values based on the implementation structure of the tree.

For Integrated Gradients, the chain rule is used and the exact gradients are used along the path of integration, e.g.,

$$\frac{\partial f}{\partial g} = \frac{\partial f}{\partial h} \cdot \frac{\partial h}{\partial g} ,$$

in which the method of computing

$$\frac{\partial f}{\partial g} {\vert}_{x = {x}_{0}}$$

is the product of

$$\frac{\partial f}{\partial h} {\vert}_{x = {x}_{0}} and \frac{\partial h}{\partial g} {\vert}_{x = {x}_{0}} .$$

Other approaches, which include Layer-wise relevance propagation (see Binder, Alexander, Montavon, Gregoire, Bach, Sebastian, Muller, Klaus-Robert, and Samek, Wojciech. Layer-wise relevance propagation for neural networks with local renormalization layers. CoRR, 2016) or DeepLift (Shrikumar, Avanti, Greenside, Peyton, and Kundaje, Anshul. Learning important features through propagating activation differences. CoRR, abs/1704.02685, 2017. URL http://arxiv.org/abs/1704.02685), use finite difference approximations of the gradients rather than exact solutions, which does not guarantee implementation invariance, e.g.,

$$\frac{f ( {x}_{0} + ϵ ) - f ( {x}_{0} )}{g ( {x}_{0} + ϵ ) - g ( {x}_{0} )} \neq \frac{f ( {x}_{0} + ϵ ) - f ( {x}_{0} )}{h ( {x}_{0} + ϵ ) - h ( {x}_{0} )} \cdot \frac{h ( {x}_{0} + ϵ ) - h ( {x}_{0} )}{g ( {x}_{0} + ϵ ) - g ( {x}_{0} )} .$$

Nullity; both Shapley and Integrated Gradient methods enforce nullity, e.g., features that do not contribute to the score will receive attribution values of zero. Shapley enforces this since it is focused on marginal contributions, that is, if the marginal impact of a feature is zero, over the space of all coalitions, its Shapley value will be zero as well. Integrated gradients enforces this by performing computing partial derivatives along the path of integration. If a feature does not contribute to a score, the attribution vector along the path integration, for the specific feature, will be zero.

Consistency; assigned decomposed values should reflect changes of the true impact of the signal upon the model, e.g., if a feature is/becomes more/less important, it should receive more/less weight. Shapley provides this guarantee by enumerating all possible permutations to measure the true influence of given variable upon the output. Integrated Gradients guarantees this by performing a path integral and attributing the partial derivatives to the individual features.

A Unified Decomposition Approach for Trees and Differentiable Models

In some embodiments, non-differentiable (e.g., tree) and differentiable models are to be explained via decomposition in a consistent manner. In some embodiments, this represents the decomposition of a single ensemble model that uses homogenous types, e.g, several tree models. In some embodiments, this represents the decomposition of a single ensemble model that uses heterogeneous types, e.g, a mixture of tree and differentiable models. In some embodiments, this represents decomposition of models (or a model) that use homogenous types, e.g, individual tree-based models. In some embodiments, this represents the decomposition of models (or a model) that use heterogenous types, e.g., a mixture of tree-based and differentiable models. In some embodiments, when studies are performed to compare various models or ensembles of model, a consistent set of test and reference pairs are selected for each experiment. In some embodiments, that process for trees and differentiable models are covered below.

A Unified Approach for Trees

In some embodiments, the non-differentiable model decomposition module 121 performs decomposition by computing Shapley values (e.g., by using Equations 1 and 2 as disclosed herein) for each observation (test data point), as disclosed herein. In some embodiments, computing Shapley values includes identifying reference data points and test data points, as enumerated herein, to be defined for the particular dataset, or cluster of datasets. In some embodiments, the non-differentiable model decomposition module computes the Shapley values for test and reference data points, e.g., vectors of \vec{s}ₜₑₛₜ and \vec{s}_{ref}. In some embodiments, the non-differentiable model decomposition module then subtracts the reference Shapley values from the test Shapley values, e.g., \vec{s}ₜₑₛₜ−\vec{s}_{ref} to explain the test data point in terms of the reference. In some embodiments, such a process could be repeated for each test-reference pair.

In some embodiments, the vector subtraction offers the added benefit of zeroing out the bias which is introduced by the underlying tree model.

In some embodiments, the Shapley values included in each vector of Shapley values sum to the pre-sigmoid value. Recall that the sigmoid function is defined as

$$S ( x ) = \frac{1}{1 + {e}^{- x}}$$

and often used for binary classification problems (e.g., probably of loan default, p∈[0,1]), such that the model will initially compute a pre-sigmoid value, [−∞, +∞], and it will be mapped onto the interval [0,1] by the sigmoid function. In this case, it implies that if the output of the Shapley decomposition returned a vector for a specific observation (test data point), and that vector summed to x, S(x) would be the observations predicted score. In some embodiments, the non-differentiable model decomposition module decomposes the pre-sigmoid value, e.g., the prediction score returned by the model, and applies an additional mapping transformation. In some embodiments, the scaling divides the pre-sigmoid Shapley values of vector by the sum of itself and multiplies by the post-sigmoid prediction score for the observation. In some embodiments, an epsilon coefficient is added to the normalization (sum of the pre-sigmoid values) to prevent numeric overflow. In some embodiments, the pre-sigmoid value Shapley vector is mapped to a score space as follows: for a Shapley vector that includes a Shapley value for each feature i (e.g., Shapley Vector={S1, S2 . . . Si}), the sum (Sum) of each value of the vector is computed (e.g., Sum=S1+S2+ . . . Si), and each Shepley value Si is divided by Sum and multiplied by the post-sigmoid prediction score for the corresponding observation (e.g., test data point, reference data point) (e.g., Si_{mapped}[Si/Sum]*S(x), where

$$S ( x ) = \frac{1}{1 + {e}^{- x}} . )$$

In some embodiments, the Shapley decomposition will directly offer a decomposition of the post-sigmoid score.

A Unified Approach for Differentiable Models

In some embodiments, to decompose predictions for differentiable models, once the test and reference data points are defined within a dataset, which may include single or multiple test data points and single or multiple reference data points, as enumerated earlier, decomposition techniques that support such models are used. In some embodiments, the differentiable model decomposition module 122 implements Integrated Gradients by Sundararajan (Sundararajan et al. 2017 https://arxiv.org/pdf/1703.01365.pdf). In some embodiments, for each test and reference pair that must be decomposed, the integral path represents a straight-line path from the reference to test data point.

In some embodiments, the particular output that is being decomposed by integrated gradients is specified by one of the model evaluation system 120 and the operator device 171. This requires that the partial derivatives be backpropagated from the specified endpoint, within the computational graph, back onto the input features. In some embodiments, a differentiable model computes a score [−∞, +∞], which is transformed through a sigmoid operation, which maps it to [0,1], as is often required for binary classification problems. In some embodiments, the backpropagation begins immediately following the sigmoid operation, e.g., computation of the partial derivatives will begin at the output (post-sigmoid value), and will flow (via the chain rule for partial derivatives) back onto the input features. In some embodiments, the backpropagation begins immediately preceding (omitting) the sigmoid operation, e.g., computation of the partial derivatives will begin at the value computed just prior to the output (pre-sigmoid value), and will flow (via the chain rule for partial derivatives) back onto the input features. In such embodiments, a mapping function is specified and applied to transform the decomposed values from the pre-sigmoid to the post-sigmoid space. In some embodiments, this transformation is equivalent to what is used by the tree-based implementation. In other embodiments, a differentiable model computes a score [−∞, +∞] that is decomposed directly. For such cases, the backpropagation will begin at the model's output and will flow back onto the input features.

Model Score Explanation Information

S271 can include: the model evaluation system generating model score explanation information for the evaluation input data set (test data point selected at S220) based on at least one decomposition generated by the method 200 (e.g, at S230, S240, S250). In some embodiments, the model evaluation system generating model score explanation information for the evaluation input data set based on the decomposition includes: generating a lookup key by using the decomposition for the ensemble model score, and performing a data lookup by using the lookup key to retrieve the model score explanation information for the evaluation input data set. In some embodiments, the lookup is a database lookup. In some embodiments, the lookup is a hash table lookup. In other embodiments the lookup is based on a semantic network. In some embodiments the lookup is based on a symbolic inference engine. In some embodiments the lookup retrieves natural language statements with included variables that refer to model features and values. In one embodiment, a natural language generator is used to generate natural language explanations based on the decomposition for the ensemble model score and the results of the lookup.

In some embodiments, the evaluation module 123 performs the process S270.

Disparate Impact Evaluation

S272 functions to generate explanation information for a test population of two or more input data sets (test data points). The explanation information can include disparate impact information that compares a model treatment of a protected class population (of input data sets) to a reference population (of input data sets). In some embodiments, the method 200 performs disparate input evaluation by selecting an observation that represents a reference population at S210, selecting a protected class population at S220, and at S230: for each observation of the protected class population, determining a decomposition relative to an observation that represents the reference population, and averaging each determined decomposition to generate a decomposition of the protected class population relative to the reference population.

In some embodiments, in performing disparate impact evaluation, S210 includes selecting a reference population, S220 includes selecting a protected class population, and S230 includes, for each observation of the protected class population, determining a decomposition relative to each observation of the reference population, and averaging each determined decomposition to generate a decomposition of the protected class population relative to the reference population.

In some embodiments, in performing disparate impact evaluation, S210 includes selecting an observation that represents a reference population, S220 includes selecting an observation that represents a protected class population, and S230 includes determining a decomposition of the protected class observation relative to the reference population observation.

In some embodiments, in performing disparate impact evaluation, S210 includes selecting a reference population, S220 includes selecting an observation that represents a protected class population, and S230 includes, each observation of the reference population, determining a decomposition of the protected class observation relative to the reference population observation, and averaging each determined decomposition to generate a decomposition of the protected class population relative to the reference population.

In some embodiments, decompositions for disparate impact analysis are performed at one or more of S240 and S250 as described herein for S230.

After performing decompositions for the protected class population relative to the reference population (e.g., at one or more of S230, S240, S250), the decomposition(s) are used at S272 to generate disparate impact information.

S272 can include identifying features having decomposition values (in the generated decompositions) above a threshold. In some embodiments, the method 200 includes providing the identified features to an operator device (e.g., 171) via a network. In some embodiments, the method 200 includes displaying the identified features on a display device of an operator device (e.g., 171). In other embodiments, the method 20 includes displaying natural language explanations generated based on the decomposition described above.

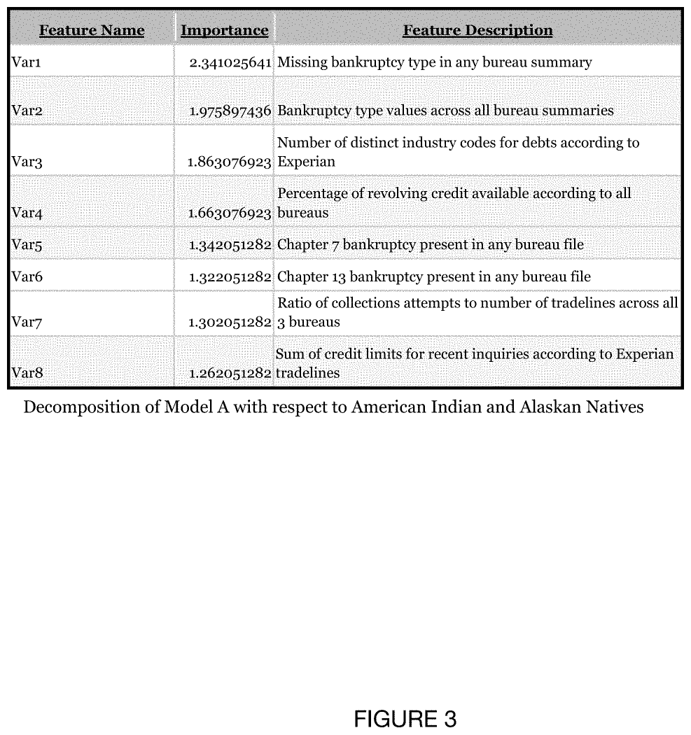

In some embodiments the method 200 includes displaying the identified features and their decomposition in a form similar to the table presented in FIG. 3.

In some embodiments, the method 200 includes determining whether an identified feature is a permissible feature for generating a score for the protected class, and providing information identifying each impermissible feature that is identified to an operator device (e.g., 171). In some embodiments, identified features are presented to an operator for further review before the identified feature is determined to be a permissible feature for generating a score for the protected class. In other embodiments, identified features are automatically determined based on the impact to protected class approvals and the business impact of including the variable. In some embodiments an identified feature is determined permissible based on leaving the feature out, retraining the model, and determining its impact on the approval rate for a protected class. In other embodiments the determination is based on an approval rate difference threshold or other tunable parameters. In some embodiments, the method 200 includes displaying partial dependence plots for identified variables, heat maps, and other visualizations on a display device of an operator device (e.g., 171).

### Model Comparison

S273 functions to generate model comparison information. S273 can include comparing decompositions for test data points across models to identify differences between models. In some embodiments, the model evaluation system performs model comparisons by: performing the method 200 for at least a first test data point selected at S210 to determine a first model decomposition for a first model score (of the first test data point) of a first model; performing the method 200 for the first test to determine a second model decomposition for a second model score (of the first test data point) of a second model. In some embodiments, the model evaluation system performing model comparisons includes: and for each test data point, the model evaluation system comparing the first model decomposition with the second model decomposition; and for each comparison, the model evaluation system providing a result of the comparison to an operator device (e.g., 171). In this manner, differences between models can be identified. In some embodiments, the method 600 compares decompositions for test populations across models to identify differences between models, in a manner similar to that described herein for test data points.

### Model Monitoring

S275 functions to generate model monitoring information. S275 can include comparing decompositions for test data points across time to identify differences over time. In some embodiments, the model evaluation system performs model monitoring by: performing the method 200 for a first test population of a first time period (selected at S210) to determine decompositions (of a first model) for the first time period; and performing the method 200 for a second test population of a second time period (selected at S210) to determine decompositions (of the first model) for the second time period. In some embodiments, the model evaluation system performing model monitoring includes: comparing decompositions (for the first model) of the first time period with decompositions (for the first model) of the second time period; and for each comparison, the model evaluation system providing a result of the comparison to an operator device (e.g., 171). In this manner, differences in model performance of the first model can be identified across time. In some embodiments, the first time period corresponds to validation of the model. In some embodiments, the first time period corresponds to training of the model. In some embodiments, the first time period corresponds use of the model in production. In some embodiments, the second period corresponds to use of the model in production.

In some embodiments, monitoring a model includes: training an autoencoder neural network on a prior set of decompositions, and using the autoencoder neural network to predict new decompositions; when the MSE of the auto-encoder's decompositions on a subset of recent decompositions exceeds a threshold computed by a function or provided as a tunable parameter, the model evaluation system generates an alert and provides the alert to the operator device to cause someone to investigate the model anomaly. In some embodiments the alert contains a description of the anomaly by way of decomposition of the autoencoder using the methods described herein.

Feature Importance

In some embodiments, S270 includes using decompositions generated by at least one of S230, S240 and S250 to generate feature importance information, and providing the feature importance information to an operator device.

Adverse Action

S271 can include functions generating explanation information for a test data point (e.g., a test data point representing a credit applicant). The explanation information can include score explanation information that provides information that can be used to explain how a score was generated for the test data point. In some embodiments, the method 200 generates score explanation information for a test data point by selecting an observation that represents a reference population at S210, selecting a test data point (e.g., representative of a credit applicant) at S220, and at S230: determining a decomposition relative to an observation that represents the reference population. In some embodiments, the method 200 generates score explanation information for a test data point by selecting a reference population at S210, selecting a test data point (e.g., representative of a credit applicant) at S220, and at S230: determining a decomposition relative to each observation that represents the reference population; and averaging each determined decomposition to generate a decomposition of test data point relative to the reference population. S271 can include using the decomposition of test data point relative to the reference population (or observation that represents the reference population) to generate explanation information that explains how the model generated the score for the test data point. This explanation information can be used to generate an Adverse Action notice, as described herein. S271 can include providing the generated model score explanation information for the test data point to an external system (e.g., an operator device, a user device, an applicant device, a modeling system, and the like).

### 12. RICHARDSON ERROR ESTIMATES FOR EXPLAINABILITY OUTPUT

In some embodiments, decomposition-based methods disclosed herein leverage the notion of explainability by reference, e.g., a test data point (or a group of test data points) (e.g., representing a person, test, sample, etc.) can be explained in terms of a reference data point (or group of reference data points). For example, at S230 and S240 of FIG. 2, a decomposition if generated for a test population relative to the reference population, and such a decomposition is an explanation of the test population in terms of the reference population (e.g., explainability of for the test population by reference to the reference population).

In some embodiments, explainability by reference, leverages the law of large numbers, a basic asymptotic assumption that in the limit that metrics are computed on repeated samples, which are drawn from a population, as the sampling process is repeated, the metrics will asymptotically converge to those representative of the true population. In the case of explainability by reference, the ‘population’ refers to the total universe of all referencial comparison, e.g., pairwise comparisons of test and reference data points, and ‘sampling’ in this context refer to selecting different events, e.g., referential comparisons.

In some embodiments, at S210, the model evaluation system 120 performs a sampling process to select a set of one or more observations of a reference population.

In some embodiments, it can be asserted that sampling from a population is akin to a data resolution problem, e.g., in an under-resolved (or under-sampled) distribution, greater fidelity is achieved by sampling additional observations (e.g., by selecting additional observations, e.g., points, of the reference population at S210).

Richardson extrapolation is a technique that allows two different solutions computed for the same mathematical system, e.g., a discretized partial differential equation on varying coarse and fine grid representations, to be combined a manner to create a more accurate representation of the solution. Richardson extrapolation is described in Richardson, L. F. (1911). “The approximate arithmetical solution by finite differences of physical problems including differential equations, with an application to the stresses in a masonry dam”. Philosophical Transactions of the Royal Society A. 210 (459-470): 307-357. doi:10.1098/rsta.1911.0009; and in Richardson, L. F.; Gaunt, J. A. (1927). “The deferred approach to the limit”. Philosophical Transactions of the Royal Society A. 226 (636-646): 299-349. doi:10.1098/rsta.1927.0008, and the contents of each are incorporated by reference herein.

In some embodiments, Richardson extrapolation is used to estimate error. In some embodiments, Richardson extrapolation is used to estimate error as described in Kamkar, 2011, “Mesh adaption strategies for vortex-dominated flows” Ph. D. Thesis, Stanford University. https://purl.stanford.edu/dk336zm3490, the contents of which is incorporated by reference herein. By comparing different solutions of various fidelity, Richardson error estimates enables quantification of the relative error, or its reduction, between two solutions, and monitoring of convergence thereof. In some embodiments, the assumptions made herein for statistical-sampling procedures generally abide by the requirements of (1) uniform and systematic refinement, (2) smooth and asymptotic solutions, and (3) dominant discretization error.

In some embodiments, the model evaluation system 120 enforces uniform and systematic refinement by uniformly sampling observations of the reference population from a dataset at S210. In some embodiments, the model evaluation system 120 guarantees smooth and asymptotic solutions from the fact that true distributions are generally smooth (free of sharp gradients) and asymptotic behavior is guaranteed by underlying principles of statistical sampling procedures. In some embodiments, dominant discretization error is supported by the fact that round-off errors and other errors, e.g., time dependent phenomena, do not exist for these rigid systems under analysis.

In some embodiments, this error estimating procedure provides two attractive qualities for data practitioners, specifically as a manner of assessing the accuracy of an explainable output:

First, when the number of observations (selected at S210) vastly exceed the intrinsic dimensionality of the data (generally speaking, the size of the input feature space), the explainability system 120 may not need to consider all observations during the process, but rather, can allow an operator (of the device 171) to tune parameters that control the tradeoff between performance and accuracy. For example, assume a model training procedure had access to 1 billion observations, each of which had 10 features, and overall model feature importance is of interest. Such a procedure would provide insight to the exact tradeoff, e.g., 10⁵ observations provides a quantifiable improvement over 10⁴. In some embodiments, the operator device 171 provides a tunable parameter E which specifies the difference between model decompositions after which the model evaluation system 120 should stop computing additional decompositions of T (test population) with respect to R_{1 . . . n} (reference population). In some embodiments, the model evaluation system 120 first initializes i=1, and then executes the following loop:

do
let Dᵢ←decomposition of T with respect to Rᵢ

while (sim(average (D_{1 . . . i-1}), average (D_{1 . . . i})≤ε and i<n))

Where sim is a suitable function mapping onto [0, 1], such as cosine, jaccard or other similarity function. In some embodiments, metrics, which are based on the underlying decomposition can be used. For example, in the case of ranking feature importance, a rank stability measure, e.g., how much has a rank re-sorted from one iteration to the next, will converge in the limit that additional decompositions are aggregated together.

Second, when the number of observations (selected at S210) is much fewer, with respect to the intrinsic dimensionality of the data, the explainability system 120 uses this error estimating procedure to quantify the inherent (available) accuracy, specifically, how selecting additional points (of the reference population) at S210 would improve a particular output. For example, assume a model had access to 10,000 observations, each of which had 300 features, and overall model feature importance is of interest. If for the given metric of interest, non-logarithmic convergence is obtained, the system 120 may suggest that additional decompositions are necessary to reach an asymptotic regime. In another embodiment, the model evaluation system 120 first determines a characteristic fit for the asymptotic convergence. In some embodiments, a logarithmic line could be fit through a linear regression type process. In these embodiments, the system 120 provides the operator device with output that specifies how additional observations will further decrease the residual according to the computed fit, e.g., regression equation.

### 13. ADVANCED/ADAPTIVE QUADRATURE METHODS FOR INTEGRATED GRADIENTS

In some embodiments, integration performed at S240 is performed by using an integration by quadrature process. In some embodiments, integration performed at S240 is performed by performing integration in accordance with at least one of the following processes: Gauss-Kronrod integration; Clenshaw-Curtis integration; integration using Richardson Error Estimation; performing integration as described in Mousavi et. al. “Efficient adaptive integration of functions with sharp gradients with sharp gradients and cusps in n-dimensional parallelepipeds”.

Decomposition for differentiable models (e.g, by using an integrated gradients processes, as described herein) often involves integration by quadrature that contains discretization errors. In some embodiments, Advanced and adaptive quadrature methods, e.g, higher-order interpolating schemas (advanced) and optimal grid refinement techniques (adaptive), are used to perform integration during S240. In some embodiments, advanced techniques may include one or more of: performing an integration using a Gauss-Kronrod formula; performing integration by using a Clenshaw-Curtis formula; performing integration by performing a Richardson Error Estimation process; performing integration by using an integration processes described in Mousavi et. al. “Efficient adaptive integration of functions with sharp gradients with sharp gradients and cusps in n-dimensional parallelepipeds”; and performing integration by performing any other suitable type process for integration by quadrature. The contents of Mousavi et. al. “Efficient adaptive integration of functions with sharp gradients with sharp gradients and cusps in n-dimensional parallelepipeds” is incorporated by reference herein. Such techniques can improve explanation of even shallow neural networks, which may contain problematic regions, e.g., representative of Heaviside functions (sharp discontinuities) or the Coulomb problem of crystalline structures (cusp-like), which might be problematic for standard Riemann-based quadrature implementations.

These advanced numerical methods can be useful in implementing performant integrated gradient calculations, as performed by the differentiable model decomposition module. In some embodiments, the number of computations linearly scales with the number of pointwise quadrature evaluations; any reduction of the total number of points to approximate the integral under examination will result in a linear reduction in runtime as well.

Numerical experiments for actual credit models have demonstrated that the number of sampling points used during integration at S240 can be reduced by five-fold to ten-fold when using these advanced techniques—offering a substantial lox performance benefit.

In some embodiments, S240 includes: the differentiable model decomposition module 122 performing decomposition of a differentiable model F(⋅), by computing the following path integral:

$${IG}_{i} ( x , {x}^{′} ) = ( {x}_{i} - {x}_{i}^{′} ) \times {\int }_{α = 0}^{1} \frac{\partial F ( {x}^{′} + α \times ( x - {x}^{′} ) )}{\partial {x}_{i}} d α \qquad Equation 3$$

where x represents the point that is being explained (point of the test population selected at S220), x′ represents the reference data point (point of the reference population selected at S210), α is a continuous parameter defined on [0,1] that defines the path of integration from the reference data point to the test data point, and IGᵢ represents the decomposition value for the i^{th} element of x, e.g., the i^{th} input feature. The integrand, represents the i^{th} partial derivative of the function, along the straight-line path from the reference to test data point. In simplified terms, this equation computes the decomposed value for each feature by integrating the partial derivative of the feature with respect to the function, e.g., the contribution of a specific feature upon the overall function from the reference to test data point.

Integration by quadrature, e.g., a discretized solution for computing the integral, is useful for numerical integration that is performed by a discrete processing unit, e.g., CPU and GPU. In some embodiments, the differentiable model decomposition module 122 computes the numerical integration procedure with a Riemman sum, as suggested by Sundararajan et al. 2017:

$${IG}_{i} ( x , {x}^{′} ) \approx ( {x}_{i} - {x}_{i}^{′} ) \times \frac{1}{m} {\sum }_{k = 1}^{m} \frac{\partial F ( {x}^{′} + \frac{k}{m} \times ( x - {x}^{′} ) )}{\partial {x}_{i}}$$

where m is the number of steps in the approximation of the integral.

In some embodiments, S240 includes: for each feature i of the a test data point of the test population: selecting at least one value along the straight line path from the value xᵢ of feature i of the test data point to the value x′ᵢ of the feature i of the corresponding reference data point; determining a derivative of the model for each selected value of the feature i along the straight line path; determining a sum of the derivatives; and determining a product of the determined sum and a difference between the value xᵢ of feature i of the test data point and the value x′ᵢ of the feature i of the reference data point, wherein the decomposition is a linear combination of the determined products for each feature i of the test data point. In some embodiments, a plurality of values along the straight line path are selected at an interval m, and the value of each determined product is divided by m.

In some embodiments, the differentiable model decomposition module 122 performs an implementation of a left Riemman sum for the above Equation 3 by executing the following set of instructions, provided here as python code:

```
def IGLeftRiemann(x_test, x_ref, m, df, i)
step_size = (1−o) / m
sum = o
for counter in range(o,m):
      del_x = counter * step_size
      x_eval = x_ref + del_x * ( x_test − x_ref )
      sum = sum + df(x_eval, i)
end
return( ( x_test[i] − x_ref[i] ) * sum / m )
```

where x_test is the test data point, x_ref is the reference data point, m is the number of discretized sections, df is a function, with inputs x_eval (the point to evaluate the partial derivative) and indx (the feature element index of x).

In some embodiments, the differentiable model decomposition module 122 uses advanced and adaptive quadrature methods, e.g., higher-order interpolating schemas (advanced) and optimal grid refinement techniques (adaptive). These advanced numerical methods may offer solutions to that yield significant performance benefit over a Riemann sum and fixed grids with uniform spacing. In some embodiments, these methods can be used to reduce the overall computational effort and achieve a similar accuracy. In other embodiments, these methods can be used to achieve an increased accuracy with comparable computational effort. In other embodiments, a balance of improved accuracy and decreased runtime can be selected.

In some embodiments, the differentiable model decomposition module 122 uses the trapezoidal rule as a higher-order scheme. In some embodiments, the model evaluation system 120 executes the following set of instructions that implement such a technique, provided here as python code:

```
def IGTrapezoidal(x_test, x_ref, m, df, i)
step_size = (1−o) / m
sum = o
for counter in range(o,m):
      del_x_left = counter * step_size
      del_x_right = counter+1 * step_size
      x_eval_left = x_ref + del_x_left * ( x_test − x_ref )
      x_eval_right = x_ref + del_x_right * ( x_test − x_ref )
      sum = sum + ( df(x_eval_left, i) + df(x_eval_right, i) ) / 2
end
return( ( x_test[i] − x_ref[i] ) * sum / m )
```

In some embodiments, the differential model decomposition module 122 performs quadrature via Simpson's rule.

In some embodiments, optimal grid refinement techniques can be used by the differential model decomposition module 122. In some embodiments, the differential model decomposition module 122 performs optimal grid refinement techniques by computing and comparing higher- and lower-order accurate representations of the underlying quadrature technique and using such information to iteratively instruct a grid refinement process, wherein specific sections exhibiting larger error will receive additional grid refinement. The process continues until some stopping criteria is reached. In some embodiments, the number of total grid points is set. In some embodiments, a lower bound on the error is set. In some embodiments, a minimum spacing between grid points could is set. In some embodiments, optimal grid refinement techniques include Gauss-Kronrod, Clenshaw-Curtis, and Richardson Error Estimation.

In some embodiments, the differentiable model decomposition module 122 uses an implementation of grid refinement by Richardson Error Estimation that involves definition of a coarse Δ x and fine ½ Δ x spacing to define a straight-line path from the reference to test data point. The differentiable model decomposition module 122 evaluates the integrand,

$$\frac{\partial F}{\partial {x}_{i}}$$

at all coarse points and all fine points. The differentiable model decomposition module 122 uses the underlying quadrature rule of Riemman to compute the local estimate, of each section. For example if Δ x=0.1, coarse spacing of 0.0, 0.1, 0.2, . . . and fine grid spacing of 0.0, 0.05, 0.1, 0.15, 0.2, . . . would be used. In such an example, the coarse sections would be [0.0, 0.1], [0.1, 0.2], etc. The differentiable model decomposition module 122 then computes error for each coarse section as e_{coarse}=abs(value_{coarse}−((value_{fine-L}+value_{fine-R})), where value_{fine-L} and value_{fine-R} represent the Riemman value generated in the fine left and right halves for the same coarse section. Grid points are added to the midpoint of all coarse sections with error values that exceed a prescribed upper bound. Additionally, once a coarse grid section has been subdivided, the overlapping fine grid (both the left and right halves) are subdivided as well. The differentiable model decomposition module 122 iteratively repeats this process until max(e_{coarse}) is below some upper bound. Furthermore, since several values are returned for each section, one for each input feature while computing

$$\frac{\partial F}{\partial {x}_{i}} ,$$

the differentiable model decomposition module 122 averages n values, where n is the number of features.

In some embodiments, S240 includes selecting a course set of points along the stightline path, evaluates the integrand,

$$\frac{\partial F}{\partial {x}_{i}}$$

at all coarse points, computes a Richardson Error Estimate (coarse Δ x) for each course section (e.g., segment between two course points) of the straightline path by using the integrand values for the coarse points. For each course section whose coarse Δ x exceeds a predetermined upper bound, a midpoint of the course selection is selected as an additional point along the straightline path (e.g., a fine point). For a course section whose coarse Δ x exceeds a predetermined upper bound, S240 can further include: evaluating the integrand,

$$\frac{\partial F}{\partial {x}_{i}}$$

at the midpoint and computing a Richardson Error Estimate (coarse Δ x) for each sub-segment of course section (e.g., the segment between the first coarse point and the midpoint, and the segment between the midpoint and the second coarse point) course points) by using the integrand values for the coarse points and the midpoint. In some embodiments, at S240, the model decomposition module 122 then computes error for the coarse section as e_{coarse}=abs(value_{coarse}−((value_{fine-L}+value_{fine-R})), where value_{fine-L} and value_{fine-R} represent the Riemman value generated sub-segment to the left of the midpoint and the subset ion to the right of the midpoint for the coarse segment being evaluated. In some embodiments, the differentiable model decomposition module 122 iteratively repeats this process of adding midpoints to sections (further reducing the coarseness of the grid points) until max(e_{coarse}) is below an upper bound. In some implementations, since several values are returned for each section, one for each input feature while computing

$$\frac{\partial F}{\partial {x}_{i}} ,$$

the differentiable model decomposition module 122 averages n values, where n is the number of features.

### 8. SYSTEM ARCHITECTURE

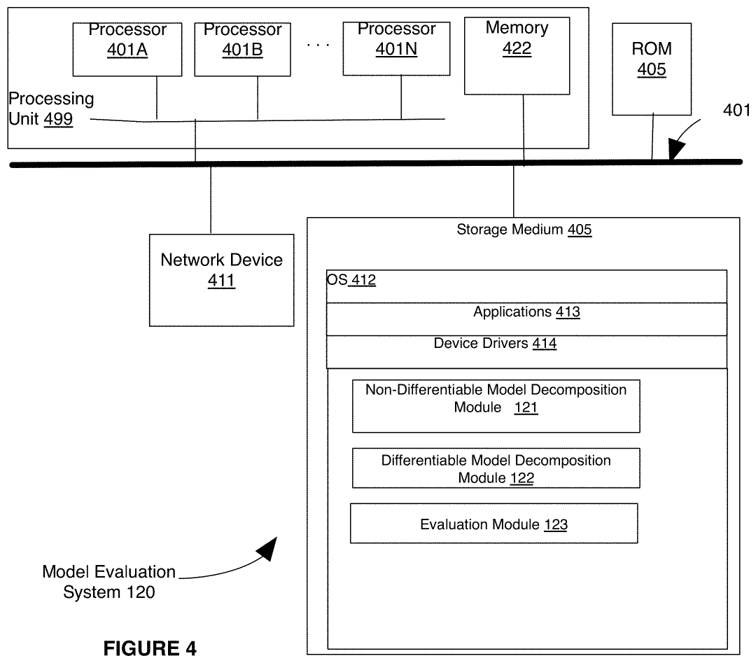

FIG. 4 is a diagram depicting system architecture of a model evaluation system, according to embodiments.

In some embodiments, the system of FIG. 4 is implemented as a single hardware server device. In some embodiments, the system of FIG. 4 is implemented as a plurality of hardware devices.

In some embodiments, the bus interfaces with the processors 401a-n, the main memory 422 (e.g., a random access memory (RAM)), a read only memory (ROM) 405, a processor-readable storage medium 405, and a network device 411. In some embodiments, at least one of a display device and a user input device.

In some embodiments, the processors include one or more of an ARM processor, an X86 processor, a GPU (Graphics Processing Unit), and the like. In some embodiments, at least one of the processors includes at least one arithmetic logic unit (ALU) that supports a SIMD (Single Instruction Multiple Data) system that provides native support for multiply and accumulate operations.

In some embodiments, at least one of a central processing unit (processor), a GPU, and a multi-processor unit (MPU) is included.

In some embodiments, the processors and the main memory form a processing unit 499. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some embodiments, the processing unit includes at least one arithmetic logic unit (ALU) that supports a SIMD (Single Instruction Multiple Data) system that provides native support for multiply and accumulate operations. In some embodiments the processing unit is a Central Processing Unit such as an Intel Xeon processor. In other embodiments, the processing unit includes a Graphical Processing Unit such as NVIDIA Tesla.

The network device 411 provides one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs. The processor-readable storage medium 405 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium includes machine-executable instructions (and related data) for an operating system, software programs, device drivers, the non-differentiable model decomposition module 121, the differentiable model decomposition module 122, and the evaluation module 123.

### 9. MACHINES

The systems and methods of some embodiments and variations thereof can be embodied and/or implemented at least in part as a machine configured to receive a computer-readable medium storing computer-readable instructions. The instructions are preferably executed by computer-executable components. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### 10. CONCLUSION

As a person skilled in the art will recognize from the previous detailed description and from the figures and claims, modifications and changes can be made to the embodiments disclosed herein without departing from the scope defined in the claims.

What is claimed is:

1. A method comprising: with a model explanation system:
accessing non-differentiable model information of a non-differentiable model;
selecting a reference population of one or more reference data points;
selecting a test population of one or more test data points;
for each test data point, generating a non-differentiable decomposition value for each feature of the test data point, wherein generating a non-differentiable decomposition value comprises:
generating a SHAP (SHapley Additive exPlanation) value for the corresponding feature for the corresponding test data point by using the non-differentiable model information;
generating a SHAP value for the corresponding feature for each reference data point by using the non-differentiable model information;
for each reference data point, generating a difference value between the SHAP value for the test data point and the SHAP value of the reference data point;
generating the non-differentiable decomposition value by averaging the generated difference values;
generating explanation information based on at least the generated non-differentiable decomposition values;
providing the generated explanation information to an external system.

2. The method of claim 1, wherein the external system includes one or more of an operator device and a modeling system.

3. The method of claim 1, wherein the non-differentiable model is a tree-based model.

4. The method of claim 1, wherein generating explanation information based on at least the generated non-differentiable decomposition values comprises: for each test data point, accessing a model result generated for the test data point by using the non-differentiable model, and mapping the model result to the non-differentiable decomposition values generated for the test data point, wherein the explanation information is generated by using the mappings of model results to non-differentiable decomposition values.

5. The method of claim 3,
wherein the non-differentiable model is a credit risk model,
wherein selecting a reference population comprises selecting input data sets of applicants approved by the credit risk model,
wherein selecting a test population comprises selecting an input data set of an applicant denied by the credit risk model,
wherein generating explanation information based on at least the generated non-differentiable decomposition values comprises:
accessing a score generated for the test data point by using the credit risk model,
accessing adverse action reason codes from at least one of a storage device and a modeling system,
selecting at least one of the adverse action reason codes based on the non-differentiable decomposition values generated for the input data set of the applicant denied by the credit risk model,
generating the explanation information, wherein the explanation information identifies the selected adverse action reason codes and the accessed score.

6. The method of claim 3,
wherein the non-differentiable model is a credit risk model,
wherein selecting a test population of one or more test data points comprises selecting input data sets of applicants that are members of a protected class,
wherein selecting a reference population comprises selecting input data sets of applicants that are members of a reference population to be compared with the members of the protected class,
wherein generating explanation information based on at least the generated non-differentiable decomposition values comprises:
for each feature, averaging the non-differentiable decomposition values generated for each test data point to generate a protected class non-differentiable decomposition value,
selecting features having a protected class non-differentiable decomposition value above a threshold,
generating the explanation information, wherein the explanation information identifies the selected features.

7. The method of claim 6, wherein generating explanation information based on at least the generated non-differentiable decomposition values further comprises:
determining whether any of the selected features are impermissible for use in the credit risk model, and
identifying any features determined to be impermissible in the generated explanation information.

8. The method of claim 7, wherein determining whether any of the selected features are impermissible for use in the credit risk model comprises:
accessing a predetermined list of impermissible features.

9. The method of claim 7, wherein determining whether any of the selected features are impermissible for use in the credit risk model comprises:
accessing training data for the credit risk model,
accessing an original credit score generated for each test data point by the credit risk model,
for each selected feature:
removing the feature from the accessed training data to generate comparison training data,
training the credit risk model by using the comparison training data to generate a comparison credit risk model for the feature,
generating a comparison credit score for each test data point by using the comparison credit risk model,
for each test data point, comparing the comparison credit score and the original credit score,
identifying the feature as impermissible based on the comparing of the comparison credit score and the original credit score for each test data point.

10. The method of claim 9,
wherein comparing the comparison credit score and the original credit score comprises determining a difference between the comparison credit score and the original credit score,
wherein identifying the feature as impermissible based on the comparing of the comparison credit score and the original credit score for each test data point comprises:
determining an average of the differences determined for each test data point, and
identifying the feature as impermissible if the average of the differences exceeds a permissibility threshold.

11. The method of claim 7, wherein selecting a reference population comprises selecting input data sets of White Non-Hispanic credit applicants.

12. The method of claim 3, further comprising,
with the model explanation system, storing in a knowledge graph: each generated non-differentiable decomposition value, information identifying the test population and the reference population, the non-differentiable model information, and the generated explanation information; and
automatically generating model risk management documentation from the information stored in the knowledge graph.

13. The method of claim 3,
wherein the non-differentiable model is a credit risk model,
wherein selecting a reference population comprises selecting input data sets of a first time period,
wherein selecting a test population of one or more test data points comprises selecting input data sets of a second time period,
wherein generating explanation information based on at least the generated non-differentiable decomposition values comprises:
for each feature, averaging the non-differentiable decomposition values generated for each test data point to generate a second time period non-differentiable decomposition value,
selecting features having a second time period non-differentiable decomposition value above a threshold,
generating the explanation information, wherein the explanation information identifies the selected features.

14. A method comprising: with a model explanation system
accessing non-differentiable model information of a non-differentiable model of an ensemble and accessing differentiable model information of a differentiable model of the ensemble;
selecting a reference population of one or more reference data points;
selecting a test population of one or more test data points;
for each test data point, generating a non-differentiable decomposition value for each feature of the test data point, wherein generating a non-differentiable decomposition value comprises:
generating a SHAP (SHapley Additive exPlanation) value for the corresponding feature for the corresponding test data point by using the non-differentiable model information;
generating a SHAP value for the corresponding feature for each reference data point by using the non-differentiable model information;
for each reference data point, generating a difference value between the SHAP value for the test data point and the SHAP value of the reference data point;
generating the non-differentiable decomposition value by averaging the generated difference values;
for each test data point, generating a differentiable decomposition value for each feature of the test data point, wherein generating a differentiable decomposition value comprises:
for each reference data point, performing an integrated gradients process using the test data point and the reference data point to generate an integrated gradient value by using the differentiable model information of the differentiable model; and
generating the differentiable decomposition value by averaging the generated integrated gradients values
for each test data point, generating ensemble decomposition values, comprising: combining non-differentiable decomposition values with corresponding differentiable decomposition values by using an ensembling function of the ensemble;
generating explanation information based on at least the generated ensemble decomposition values; and
providing the generated explanation information to an external system.

15. The method of claim 14, wherein the non-differentiable model is a tree model and the differentiable model is a neural network.

16. The method of claim 15, wherein the ensemble is a continuous function.

17. The method of claim 16,
wherein the ensemble is a credit risk model,
wherein selecting a reference population comprises selecting input data sets of applicants approved by the credit risk model,
wherein selecting a test population comprises selecting an input data set of an applicant denied by the credit risk model,
wherein generating explanation information based on at least the generated ensemble decomposition values comprises:
accessing a score generated for the test data point by using the credit risk model,
accessing adverse action reason codes from at least one of a storage device and a modeling system,
selecting at least one of the adverse action reason codes based on the ensemble decomposition values generated for the input data set of the applicant denied by the credit risk model,
generating the explanation information, wherein the explanation information identifies the selected adverse action reason codes and the accessed score.

18. The method of claim 16,
wherein the ensemble is a credit risk model,
wherein selecting a test population of one or more test data points comprises selecting input data sets of applicants that are members of a protected class,
wherein selecting a reference population comprises selecting input data sets of applicants that are members of a reference population to be compared with the members of the protected class,
wherein generating explanation information based on at least the generated ensemble decomposition values comprises:
for each feature, averaging the ensemble decomposition values generated for each test data point to generate a protected class ensemble decomposition value,
selecting features having a protected class ensemble decomposition value above a threshold,
generating the explanation information, wherein the explanation information identifies the selected features.

19. The method of claim 16,
wherein the ensemble model is a credit risk model,
wherein selecting a reference population comprises selecting input data sets of a first time period,
wherein selecting a test population of one or more test data points comprises selecting input data sets of a second time period,
wherein generating explanation information based on at least the generated ensemble decomposition values comprises:
for each feature, averaging the ensemble decomposition values generated for each test data point to generate a second time period ensemble decomposition value,
selecting features having a second time period ensemble decomposition value above a threshold,
generating the explanation information, wherein the explanation information identifies the selected features.

20. The method of claim 16, further comprising, with the model explanation system:
storing in a knowledge graph: each generated non-differentiable decomposition value, each generated differentiable decomposition value, each generated ensemble decomposition value, information identifying the test population and the reference population, the non-differentiable model information, the differentiable model information, and the generated explanation information; and
automatically generating model risk management artifacts and documentation from the information stored in the knowledge graph.
